(19) United States
(12) Patent Application Publication
(10) Pub. No.: US 2019/0139720 A1
(43) Pub. Date: May 9, 2019

(54) ENERGY EFFICIENT ELECTROMAGNETIC CONTACTOR USING HEART SHAPED DRIVING PIN OPERATING MECHANISM

(71) Applicant: BINAY KUMAR, VADODARA (IN)

(72) Inventor: BINAY KUMAR, VADODARA (IN)

(73) Assignee: BINAY KUMAR, VADODARA (IN)

(21) Appl. No.: 16/095,870

(22) PCT Filed: Apr. 28, 2017
(86) PCT No.: PCT/IN2017/000095

§ 371 Date: Oct. 31, 2018

(30) Foreign Application Priority Data
May 3, 2016 (IN) 201621015311

(51) Int. Cl. H01H 9/24; H01H 3/42; H01H 50/32; H01H 50/54; H01H 50/58

(52) U.S. Cl. CPC H01H 9/24; H01H 3/42; H01H 50/58; H01H 50/546; H01H 50/32

(57) ABSTRACT

Energy Efficient Electromagnetic Contactor (EEEC) according to preferred embodiments of the present disclosure may include a lower body casing L, upper body casing U1, U2, U3, U4 or U5, a plurality of fixed contacts 11, 12 and 13, each of the fixed contacts having terminal end and a contact end, a plurality of movable contacts 34 and 35, each of the movable contacts being associated with a different one of the fixed contacts for making an electrical connection at a contact point with the contact end of the associated fixed contact, movable contacts support, bobbin coil, stationary iron core, movable iron core, bobbin, conical returning spring, driving member/latching member heart shaped driving pin operating mechanism and in another preferred embodiments electromagnetic protraction-retraction operating mechanism. The object of the invention is to provide an electromagnetic contactor which enables switching ON or switching OFF the contactor using a power supply for a short period and to keep the contactor in ON state no continuous power is required and also even when the power gets OFF the closed contacts of the electromagnetic contactor will not open and changed its state when the operating coil 4 is energized again for a short moment resulting in to conservation of energy, improved reliability, economical in cost and space and low maintenance. In another embodiment the electromagnetic protraction-retraction operating mechanism is used for operation of the EEEC. Some embodiments to provide interlocking mechanism in which change of state of the EEEC from energised state to de-energised state is possible only when lever arms Z1c and Z2b of electromagnetic armature lifter Z1 and pull type actuator solenoid Z2 is attracted by energisation of coil Z1g and Z2a respectively.

FIG.-16 should be included for the Abstract.

### FIELD AND BACKGROUND OF THE INVENTION

### A. Field of the Invention:

The present invention relates to an electromagnetic contactor energized de energized for making it ON and again energized and de energized for making it OFF using a single push button switch and will remain in changed state without further needing any electrical power source.

### B. Description of the Prior Art:

FIGS. 22, 22a, 22b, 22c, 22d, 17 and 18 in combination illustrate a well-known triple-pole electromagnetic contactor EC that includes two auxiliary contact point. FIG. 21 illustrates a well-known start/stop button control system using two push button switch, one push button NO switch P and other push button NC switch Q and also using one auxiliary contact 13 in switching ON and OFF circuit of the electromagnetic contactor EC. An upper body casing U is formed of synthetic resin or any other insulating material and has side walls 28 and 29. Partition walls 27 are provided between these side walls 28 and 29 and acts like insulating wall between two adjacent contacts. These insulating partition walls 27 also defined insulating sections or domains, the number of which corresponds to the number of poles. Main fixed contacts 11 having screw terminals 11a and fixed contacts point 33 are provided between the side wall 28 and the neighboring partition walls 27 and between the respective partition walls 27, as shown in the FIGS. 22 and 22a. A movable contact support 32 is guided to be slidable on the axial line of the upper body casing U in a central guide groove 52 formed between the fixed contacts 11 as shown in the FIG.-22d.

The movable contacts support 32 as shown in FIG. 22c is formed with windows 44 extending in the longitudinal direction of the main fixed contacts 11 and windows 45 extending in the longitudinal direction of the auxiliary contacts 12 and 13. In a window 44, a movable contact 34 including contact points 34a for bridging (closing) and releasing (opening) the fixed contact points 33 of the main fixed contacts 11 is supported together with a contact spring 36 and a receiving member 36a as shown in FIG.-22d. In windows 45, a movable contacts 35 including contact points 35a for bridging (closing) and releasing (opening) the fixed auxiliary contact points 12 and 13 of the auxiliary fixed contacts 12b and 13b respectively is supported together with a contact spring 36 and a receiving member 36a. The movable contacts support 32 is linked to a movable iron core 10 and coupled to it by a supporting plate 10y inserted in grooves 46 of the movable contact support 32 and a window 10z in the movable iron core 10 at its bottom side. The movable iron core 10 is attracted or released from a driving electromagnet accommodated in the lower body casing L.

A stationary iron core 9, which is E-shaped similar to the E-shaped movable iron core 10, is provided with a supporting plate 9z inserted inside its window 9n and covered at their ends with elastic bodies 9m (not shown in the FIG. 22d), is placed inside the lower body casing L. Shading coils 9x are provided at top end of the outer legs 9b. Individual laminated steel/iron cores are stacked and made a single unit of the stationary iron core 9 by using rivets 9y. Individual laminated steel/iron cores are stacked and made a single unit of the movable iron core 10 by using rivets 10x.

A bobbin 5 may include an upper plate, a lower plate, a coil accommodation portion, two terminal strips 7 accommodation portion and the top plate should be able to accommodate lower portion of a returning spring 37. A bobbin coil 4 is placed in the central leg 9a of the stationary iron core 9.

The operating coil 4 is wound around the bobbin 5, and the bobbin 5 is fixed and coupled to one side of the lower body casing L and the coil accommodation portion is partly inserted in the central leg 9a of the core 9 which is also central portion of the lower body casing L. The terminal strips 7 fixed in the bobbin 5. Terminals 4x of the operating coils are connected to the terminal strips 7. Protrudes 6 in the bobbin 5 is provided for insulating wall between two terminal strips 7 of the coil 4.

The upper body casing U is configured to cover the lower body casing L.

The returning spring 37 is provided at the upper plate of the bobbin 5 and central leg 10a of the movable core 10 is inserted in the upper end of the returning spring 37. The movable contacts support 32, coupled to the movable contacts 34 and 35, coupled to the movable iron core 10 is placed inside the guide groove 52 of the upper body casing U. The upper body casing U is pressed against the lower body casing L and covered and locked. The fixed contacts 11, 12 and 13 are inserted in their respective grooves 51. Terminal washers 16 are inserted in terminal screws 17 and the terminal screws 17 are screwed in the screw terminals 11a of the fixed contacts 11. Terminal washer 18 is inserted in terminal screw 19 and the terminal screw 19 is screwed in the screw terminal 12a of the auxiliary fixed contact 12. Terminal washer 15 is inserted in terminal screw 14 and the terminal screw 14 is screwed in the screw terminal 13a of the auxiliary fixed contact 13.

Top cover 22 is fixed to top surface, in axial direction, of the upper body casing U and terminal covers 2s are fixed above the fixed terminals 11 and 12.

When a voltage is impressed upon the operating coil 4 of the electromagnetic contactor EC as described above, the stationary core 9 provided at lower portion gets magnetized and attracts movable iron core 10. As a result, the movable contacts support 32 is lowered and the movable contacts points 34a touches the fixed contacts points 33 there by closing their electrical circuit i.e. bridging the fixed contacts 11. When the voltage applied to the operating coil 4 is terminated, the attraction force between the stationary core 9 and the movable core 10 extinct and due to restoring force of the returning coil 37, the movable core 10 is separated from the stationary core 9 and hence the movable contacts structure 32 moved away from the fixed contacts 11 and the movable contacts 34 from the fixed contacts 11 resulting in breaking electrical circuit.

FIG. 21 shows a circuit diagram of existing start/stop double push button motor control system using the existing electromagnetic contactor (prior art) EC. The wiring diagram shown in the FIG. 21 shows that one end of the operating coil 4 of the electromagnetic contactor EC is connected to the power supply 2 through a cable 50a, NC Push button switch Q, cable 50b, cable 50c, NO push button switch P, cable 50e, cable 50f and other end is connected by a cable 50h when the coil 4 is de-energised. Another cable connection for the operating coil 4 is, one end of the operating coil 4 of the electromagnetic contactor EC is connected to the power supply 2 through a cable 50a, NC Push button switch Q, cable 50b, cable 50d, the auxiliary fixed contact 13, the movable contact 35, the auxiliary fixed contact 13, cable 50g, cable 50f and other end is connected by a cable 50h when the coil 4 is de-energised. When the coil 4 is in de-energised state the movable contact 35 does not bridge the auxiliary fixed contacts 13 i.e. the contact 13 is open. The circuit diagram shown in the FIG.21 is a condition when the electromagnetic contactor EC is in de-energised state and no power is fed to the Load and to the operating coil 4. When the operating coil 4 is energized by pressing NO push button switch P, the power is fed to the coil 4 and it energized resulting into closing of normally open auxiliary contact 13-35-13 and 12-35-12 and main contacts 11-34-11. When the push button P is released the power supply 2 to the coil 4 is still fed via the closed auxiliary contact 13 -35-13. Power supply 1 to the load is fed through the triple-poles main contacts 11-34-11 closing i.e. bridging of the fixed contacts 11 by the movable contacts 34. When the NC push button Q is pressed, power supply 2 to the operating coil 4 is terminated and the coil 4 is de-energised resulting into opening of the auxiliary contacts 13-35-13, 12-35-2 and main contacts 11-34-11.

C. Drawback in the existing electromagnetic contactor EC:

In the existing electromagnetic contactor EC, for operation of the operating coil two push button switches P and Q in addition to one auxiliary contacts and a lot of cables are required. For fixing two push button switches more space is required in control panel where it is fixed. More space is also required for cabling. Also more man hours required to assemble this start/stop button control system and more maintenance required. Also for keeping operating coil in energized state minimum required voltage is required to keep the movable core 10 attracted with the stationary core 9. In the area where heavy loads like pumps, machines, cranes etc. are working, the chances of voltage drop is much more resulting into opening of contacts of the existing electromagnetic contactor EC. Also to keep the operating coil 4 in excited state continuous power supply 2 is required. So the electromagnetic contactor EC is consuming a lot of electrical power and it also resulted into lower life cycle, more chances of failure, higher cost. It also required to switch ON every time when ever power supply is ON after OFF.

Hence to solve the above problem and also to conserve not only electrical energy but also save man hours and material costs in addition to space and increasing life cycle is achieved in the present invention Energy Efficient Electromagnetic Contactor EEEC

### SUMMARY OF THE INVENTION

The present invention Energy Efficient Electromagnetic Contactor EEEC is thought of and made to solve the above problems and objects of the present invention Energy Efficient Electromagnetic Contactor EEEC in preferred embodiments is to provide an electromagnetic contactor having operating mechanism to keep the present invention Energy Efficient Electromagnetic Contactor EEEC in a state when the operating coil 4 is energized for a short moment and changed its state when the operating coil is energized again for a short moment resulting in to conservation of energy, improved reliability, economical in cost and space and low maintenance. No continuous power is required for keeping the operating coil 4 of the present invention Energy Efficient Electromagnetic Contactor EEEC in energized state.

Another object of the present invention Energy Efficient Electromagnetic Contactor EEEC in another embodiments is to provide interlocking mechanism in which change of state of the EEEC from energised state to de-energised state is possible only when lever arms Z1c and Z2b of electromagnetic armature lifter and pull type actuator solenoid Z2 is attracted by energisation of coil Z1g and Z2a respectively after energisation and then de-energisation of the operating coil 4 of the present invention Energy Efficient Electromagnetic Contactor EEEC.

Another objects of the present invention Energy Efficient Electromagnetic Contactor EEEC is to increase life cycle of the operating coil 4 and reduce temperature and reduce noise inside the control panel where the contactor EEEC is installed.

The object of the invention is to provide an electromagnetic contactor which enables switching ON or switching OFF the contactor using a power supply for a short period and to keep the contactor in ON state no continuous power is required and also even when the power gets OFF the closed contacts of the electromagnetic contactor will not open.

These and other objects are accomplished by this present invention Energy Efficient Electromagnetic Contactor EEEC comprising a lower body casing L, upper body casing U1, U2, U3, U4 or U5, a plurality of fixed contacts 11, 12 and 13, each of the fixed contacts having terminal end and a contact end, a plurality of movable contacts 34 and 35, each of the movable contacts being associated with a different one of the fixed contacts for making an electrical connection at a contact point with the contact end of the associated fixed contact, movable contacts support, bobbin coil, stationary iron core, movable iron core, bobbin, conical returning spring, driving member/latching member mechanism and electromagnetic armature lifter Z1 and pull type actuator solenoid Z2 in some embodiments and in another preferred embodiments retraction-contraction mechanism.

### BRIEF DESCRIPTION OF THE DRAWINGS

The descriptions, various embodiments and symbols of the present invention EEEC are illustrated in the various drawings as detailed below:

FIG.-1 is a perspective view of first embodiment EEEC11 of the present invention Energy Efficient Electromagnetic Contactor EEEC.

FIG.-2a is a perspective view of the first embodiment of the present invention Energy Efficient Electromagnetic Contactor EEEC without top cover 22.

FIG.-2b is a perspective view of the first embodiment of the present invention Energy Efficient Electromagnetic Contactor EEEC without the top cover 22 and movable contacts support assembly 120.

FIG.-2c is a perspective view of the first embodiment of the present invention Energy Efficient Electromagnetic Contactor EEEC without the top cover, the movable contacts support assembly, pull type actuator electromagnetic solenoid Z2 and electromagnetic armature lifter Z1.

FIG.-2d is a perspective view of the first embodiment of the present invention Energy Efficient Electromagnetic Contactor EEEC without the top cover, the movable contacts support assembly, the pull type actuator electromagnetic solenoid, the electromagnetic armature lifter and top terminal covers 20.

FIG.-2e is a perspective view of upper body casing U1 of the first embodiment of the present invention Energy Efficient Electromagnetic Contactor EEEC.

FIG. 2f is a imaginary cut plane sectional and partly perspective view of the upper body casing U1, U2, U3 and U4 of the first, the second, the third and the fourth embodiment cut by an imaginary plane A-A′, B-B′, D-D′ and E-E′ respectively of the present invention Energy Efficient Electromagnetic Contactor EEEC.

FIG.-2f is a partly perspective view of the movable contacts support assembly and partly cross sectional view of central portion of the upper body casing U1 of the first embodiment of the present invention Energy Efficient Electromagnetic Contactor EEEC with the pull type actuator electromagnetic solenoid and the electromagnetic armature lifter available.

FIG.-2g is a partly perspective view of the movable contacts support assembly and partly cross sectional view of central portion of the upper body casing U1 of the first embodiment of the present invention Energy Efficient Electromagnetic Contactor EEEC with the electromagnetic armature lifter available.

FIG.-2h shows relative position of partly perspective view of the movable contacts support assembly 120 and partly cross sectional view of the central portion of the upper body casing 111 and U3 of the first and third embodiment respectively of the present invention Energy Efficient Electromagnetic Contactor EEEC when the Energy Efficient Electromagnetic Contactor EEEC is in OFF condition.

FIG.-2i shows relative position of partly perspective view of the movable contacts support assembly 120 and partly cross sectional view of the central portion of the upper body casing U1 and U3 of the first and third embodiment respectively of the present invention Energy Efficient Electromagnetic Contactor EEEC when the Energy Efficient Electromagnetic Contactor EEEC is in ON condition.

FIG.-2j is a enlarged partly cross sectional view of a small top portion of the central guide groove of the upper body casing U1 and U3 of the first and third embodiment respectively of the present invention Energy Efficient Electromagnetic Contactor EEEC.

FIG.-3 is a perspective view of the second embodiment EEEC12 of the present invention Energy Efficient Electromagnetic Contactor EEEC.

FIG.-3a is a perspective view of the second embodiment of the present invention Energy Efficient Electromagnetic Contactor EEEC without the top cover.

FIG.-3b is a perspective view of the second embodiment of the present invention Energy Efficient Electromagnetic Contactor EEEC without the top cover, the movable contacts support assembly, the pull type actuator solenoid, the electromagnetic armature lifter and the top terminal cover.

FIG.-3c is a perspective view of upper body casing U2 of the second embodiment of the present invention Energy Efficient Electromagnetic Contactor EEEC.

FIG.-3d shows relative position of partly perspective view of the movable contacts support and partly cross sectional view of the central portion of the upper body casing U2 and U4 of the second and fourth embodiment respectively of the present invention Energy Efficient Electromagnetic Contactor EEEC when the Energy Efficient Electromagnetic Contactor EEEC is in OFF condition.

FIG.-3e shows relative position of partly perspective view of the movable contacts support and partly cross sectional view of the central portion of the upper body casing U2 and U4 of the second and fourth embodiment respectively of the present invention Energy Efficient Electromagnetic Contactor EEEC when the Energy Efficient Electromagnetic Contactor EEEC is in ON condition.

FIG.-3f is a partly cross sectional view of a small top portion of the central guide groove of the upper body casing U2 and U4 of the second and fourth embodiment respectively of the present invention Energy Efficient Electromagnetic Contactor EEEC.

FIG.-4a is an exploded view of moving contacts support assembly comprising of the moving contacts support, a connector and a screw of the first, the second, the third and the fourth embodiment of the present invention Energy Efficient Electromagnetic Contactor EEEC.

FIG.-4b is a perspective view of the moving contacts support assembly 120 of the first, the second, the third and the fourth embodiment of the present invention Energy Efficient Electromagnetic Contactor EEEC.

FIG.-4c is a cut plane perspective view of slider projection 103c cut by a imaginary curved plane surface C-C′ of the first, the second, the third and the fourth embodiment of the present invention Energy Efficient Electromagnetic Contactor EEEC.

FIG.-5a is a perspective view of a driving member (lever-pin) arrangement of the second and the fourth embodiment of the present invention Energy Efficient Electromagnetic Contactor EEEC;

FIG.-5b is a perspective view of a thumb screw of the second and the fourth embodiment of the present invention Energy Efficient Electromagnetic Contactor EEEC;

FIG.-6 is a perspective view of a latching member/driving member of the first and the third embodiment of the present invention Energy Efficient Electromagnetic Contactor EEEC;

FIG.-7 is a perspective view of a stopper pin of the first and the third embodiment of the present invention Energy Efficient Electromagnetic Contactor EEEC;

FIG.-8 is a schematic representation in sections of heart shaped channel profile illustrating the camming steps followed by a pin of the driving member 202 of the second and the fourth embodiment and one end 117b of the latching member 117 of the first and the third embodiment of the present invention Energy Efficient Electromagnetic Contactor EEEC when the EEEC is operated for ON and OFF.

FIG.-9(a) is a front view and FIG.-9(b) is a top view of the electromagnetic armature lifter of the first and the second embodiment of the present invention Energy Efficient Electromagnetic Contactor EEEC;

FIG.-10(a) is a front view and FIG.-10(b) is a top view of the pull type actuator solenoid of the first and the second embodiment of the present invention Energy Efficient Electromagnetic Contactor EEEC;

FIG.-11 is a relative position of lever arm of the electromagnetic armature lifter and lever arm of the pull type actuator solenoid with respect to the movable contact support 103 of the moving contacts support assembly 120 of the first, the second, the third and the fourth embodiment of the present invention Energy Efficient Electromagnetic Contactor EEEC when the EEEC is in OFF condition.

FIG.-12 is a relative position of lever arm of the electromagnetic armature lifter and lever arm of the pull type actuator solenoid with respect to the movable contact support 103 of the moving contacts support assembly 120 of the first, the second, the third and the fourth embodiment of the present invention Energy Efficient Electromagnetic Contactor EEEC when the EEEC is in ON condition.

FIG.-13 is a relative position of lever arm of the electromagnetic armature lifter and lever arm of the pull type actuator solenoid with respect to the movable contact support 103 of the moving contacts support assembly 120 of the first, the second, the third and the fourth embodiment of the present invention Energy Efficient Electromagnetic Contactor EEEC when operating coils of the electromagnetic armature lifter and the pull type actuator solenoid are energized.

FIG.-14 is a perspective view of the third embodiment EEEC13 and the forth embodiment of the present invention Energy Efficient Electromagnetic Contactor EEEC.

FIG.-14a is a perspective view of the third embodiment of the present invention Energy Efficient Electromagnetic Contactor EEEC without the top cover, the movable contacts support assembly and the top terminal cover.

FIG.-14b is a perspective view of the upper body casing U3 of the third embodiment of the present invention Energy Efficient Electromagnetic Contactor EEEC.

FIG.-15 is a perspective view of the fourth embodiment EEEC14 of the present invention Energy Efficient Electromagnetic Contactor EEEC.

FIG.-15a is a perspective view of the fourth embodiment of the present invention Energy Efficient Electromagnetic Contactor EEEC without the top cover, the movable contacts support assembly and the top terminal cover.

FIG.-15b is a perspective view of the upper body casing 14 of the fourth embodiment of the present invention Energy Efficient Electromagnetic Contactor EEEC.

FIG.-16 is a perspective view of fifth embodiment EEEC2 of the present invention Energy Efficient Electromagnetic Contactor EEEC.

FIG.-16a is a perspective view of the fifth embodiment of the present invention Energy Efficient Electromagnetic Contactor EEEC without the top cover.

FIG.-16b is a perspective view of the fifth embodiment of the present invention Energy Efficient Electromagnetic Contactor EEEC without the top cover, movable contacts support assembly and the top terminal cover.

FIG.-16c is a perspective view of upper body casing 15 of the fifth embodiment of the present invention Energy Efficient Electromagnetic Contactor EEEC.

FIG.-16c′ is a cut plane perspective view of the upper body casing U5 of the fifth embodiment cut by an imaginary plane F-F′ of the present invention Energy Efficient Electromagnetic Contactor EEEC.

FIG.-16d shows relative position of partly perspective view of the movable contacts support assembly 515 and partly cross sectional view of the central portion of the upper body casing U5 of the fifth embodiment of the present invention Energy Efficient Electromagnetic Contactor EEEC when the Energy Efficient Electromagnetic Contactor EEEC is in OFF condition.

FIG.-16e shows relative position of partly perspective view of the movable contacts support assembly 515 and partly cross sectional view of the central portion of the upper body casing U5 of the fifth embodiment of the present invention Energy Efficient Electromagnetic Contactor EEEC when the Energy Efficient Electromagnetic Contactor EEEC is in ON condition.

FIG.-16f is a perspective view of the moving contacts support assembly 515 of the fifth embodiment of the present invention Energy Efficient Electromagnetic Contactor EEEC.

FIG.-16g is a perspective view of the moving contacts support 503 of the fifth embodiment of the present invention Energy Efficient Electromagnetic Contactor EEEC.

FIG.-16h is an exploded view of the partly cut section of the moving contacts support assembly 515, perspective view of the spring 504, bushing 505, latch element 506, tubular latch actuating element 507, coupler 508, connector 509 and screw 510 of the fifth embodiment of the present invention Energy Efficient Electromagnetic Contactor EEEC.

FIG.-16i is a front view and top view of the latch element 506 of the fifth embodiment of the present invention Energy Efficient Electromagnetic Contactor EEEC.

FIG.-16j is a front view and top view of the tubular latch actuating element 507 of the fifth embodiment of the present invention Energy Efficient Electromagnetic Contactor EEEC.

FIG.-16k is a front view and top view of the bushing 505 of the fifth embodiment of the present invention Energy Efficient Electromagnetic Contactor EEEC.

FIG.-16l is a front view and top view of the coupler 508 of the fifth embodiment of the present invention Energy Efficient Electromagnetic Contactor EEEC.

FIG.-16m is a schematic diagram illustrating inside three teethes out of four teethes of the latch element 506 of the fifth embodiment of the present invention Energy Efficient Electromagnetic Contactor EEEC.

FIG.-16n is a schematic diagram illustrating relative position of top surface of the teethes of the latch element 506 and top surface of teethes of cylindrical projection 503b of the movable contacts support 503 of the fifth embodiment of the present invention Energy Efficient Electromagnetic Contactor EEEC when the EEEC is ON.

FIG.-16p is a schematic diagram illustrating relative position of top surface of the teethes of the latch element 506 and top surface of teethes of cylindrical projection 503b of the movable contacts support 503 of the fifth embodiment of the present invention Energy Efficient Electromagnetic Contactor EEEC when the EEEC is OFF.

FIG.-16q is a partly cut section in front view and top view of a barrel 514 and top and bottom walls of the central guide groove of the upper body casing 115 of the present invention Energy Efficient Electromagnetic Contactor EEEC.

FIG.-16r is a schematic diagram illustrating relative position of a downwardly projecting teeth 506c of a projecting ear 506b of the latch element 506 with respect to the latch receiving means of the barrel 514 at various stages of operation of the movable contacts support assembly 515 (retraction-protraction mechanism) of the present invention Energy Efficient Electromagnetic Contactor EEEC when the EEEC is energized -de energized and again energized-de energised.

FIG.-17 is a perspective view of the top cover of the present invention Energy Efficient Electromagnetic Contactor EEEC.

FIG.-18 is a perspective view of the terminal cover of the present invention Energy Efficient Electromagnetic Contactor EEEC.

FIG.-19 is a start/stop button control system using the first, second, third or fourth embodiments EEEC11, EEEC12, EEEC13 or EFEC14 symbol respectively of the present invention Energy Efficient Electromagnetic Contactor EEEC.

FIG.-20 is a start/stop button control system using the fifth embodiment (EEEC2) of the present invention Energy Efficient Electromagnetic Contactor EEEC.

FIG.-21 is a start/stop button control system using the existing electromagnetic contactor (prior art) EC.

FIG.-22 is a perspective view of the existing electromagnetic contactor EC (Prior art).

FIG.-22a is a perspective view of the existing electromagnetic contactor EC without top terminal cover (Prior art).

FIG.-22b is a perspective view of the upper body casing U of the existing electromagnetic contactor EC (Prior art).

FIG.-22c is a perspective view of the moving contacts support assembly 32 of the existing electromagnetic contactor EC (Prior art).

FIG.-22d is a partly cross section view, partly exploded view of the existing electromagnetic contactor EC (Prior art) which are partly similar to the present invention EEEC.

### KEY TO ILLUSTRATIONS

U1. Upper body casing of First Embodiment of the present invention Energy Efficient Electromagnetic Contactor EEEC.
U2. Upper body casing of Second Embodiment of the present invention Energy Efficient Electromagnetic Contactor EEEC.
U3. Upper body casing of Third Embodiment of the present invention Energy Efficient Electromagnetic Contactor EEEC.
U4. Upper body casing of Fourth Embodiment of the present invention Energy Efficient Electromagnetic Contactor EEEC.
U5. Upper body casing of Fifth Embodiment of the present invention Energy Efficient Electromagnetic Contactor EEEC.
U Upper body casing of existing electromagnetic contactor (Prior art).
L. Lower body casing of the present invention Energy Efficient Electromagnetic Contactor EEEC as well as the existing electromagnetic contactor (Prior art).
P. NO push button switch
Q. NC push button switch
A-A′ Imaginary cut plane in the upper body casing U1
B-B′ Imaginary cut plane in the upper body casing U2
C-C′ Imaginary cut curved plane in the movable contact support 103.
D-D′ Imaginary cut plane in the upper body casing U3
E-E′ Imaginary cut plane in the upper body casing U4
F-F′ Imaginary cut plane in the upper body casing U5
EEEC. Energy Efficient Electromagnetic Contactor.
EEEC11. Symbol for First embodiment of the present invention Energy Efficient Electromagnetic Contactor EEEC.
EEEC12. Symbol for Second embodiment of the present invention Energy Efficient Electromagnetic Contactor EEEC.
EEEC13. Symbol for Third embodiment of the present invention Energy Efficient Electromagnetic Contactor EEEC.
EEEC14. Symbol for Fourth embodiment of the present invention Energy Efficient Electromagnetic Contactor EEEC.
EEEC2. Symbol for Fifth embodiment of the present invention Energy Efficient Electromagnetic Contactor EEEC.
EC. Symbol for the existing electromagnetic contactor (Prior art)
Z1. Electromagnet armature lifter of the present invention Energy Efficient Electromagnetic Contactor EEEC.
Z1a. Armature return spring; Z1b. Capacitor; Z1c. Hinged armature or lever arm; Z1d. Stopper plate; Z1e. Magnetic iron structure or yoke; Z1f Cover body; Z1g. Operating coil; Z1h. Screw; Z1i. Core; Z1j. Coil bobbin; Z1k. Bearing (Hinge); Z1g. The operating coil, Z1m terminals wire; Z1n. Insulated terminal strips; Z1p. Terminals of the capacitor; Z1q. Metal cut bent in the iron structure Z1e for connecting one end of armature Z1c by the spring Z1a; Z1r. Hole; Z1s. Side plates in the iron structure Z1e;
Z2. Pull type actuator solenoid of the present invention Energy Efficient Electromagnetic Contactor EEEC;
Z2a. Operating coil or solenoid coil; Z2b. Lever arm attached to armature Z2f; Z2c. Stopper plate; Z2d. Screw; Z2e. Conical compression spring or armature returning spring; Z2f Armature; Z2g. Magnetic iron structure or yoke; Z2h. Side plates of the iron structure Z2g; Z2i. Screw; Z2j. Terminals of the coil Z2a; Z2k. Insulated terminals strip; Z2l. Cover body; Z2m. Hole;
1. Hole; 2. Hole; 3. Protrudes in the lower body casing L; 4. Operating coil or bobbin coil; 4x. Two terminals of the coil 4; 5. Bobbin; 6. Protrudes in the bobbin 5; 7. Terminal strips; 7a. Screw terminals; 8. Screw connected to the terminal strip 7; 9. Stationary iron core; 9a. Central leg of the core 9; 9b. Outer leg of the core 9; 9m. Elastic bodies (Not shown in the FIG-22d); 9n. Window; 9x. Shading coils; 9y. Rivets; 9z. Supporting plates; 10. Movable iron core; 10a. Central leg of the core 10; 10b. Outer leg of the core 10; 10x. Rivets; 10y. Supporting plate; 10z. Triangular window; 11. Main fixed contacts; 11a. Screw terminals; 12. Auxiliary fixed contact; 12a. Screw terminals; 12b. Auxiliary fixed contact points; 13. Auxiliary fixed contact; 13a. Screw terminals; 13b. Auxiliary fixed contact points; 14. Terminal screw attached to the auxiliary contact 13; 15. Terminal washer for the auxiliary contact 13; 16. Terminal washers for the main contacts 11; 17. Terminal screw attached to the main contacts 11; 18. Terminal washer for the auxiliary contact 12; 19. Terminal screw attached to the auxiliary contact 12; 20. Terminal covers; 20a. Top surface; 20b. Side support protrudes; 20c. Notches; 20d. Stop projection; 20e. Stop projection; 20f. Slits; 21. Hole in the terminal cover 20; 22. Top body cover; 22a. Protrudes with stop grooves; 22b. Side support protrudes; 22c. Top surface; 23. Upper protrudes in the top body cover 22; 24. Lower protrude in the top body cover 22; 25. Locking cut in the top surface 22c; 26. Trapezoidal grooves in the upper body casing U; 27. Inter pole partition walls; 28. Side wall; 29. Side wall; 30. Stop groove; 31. Stop groove; 32. Movable contacts support assembly; 32a. Connector for attaching external movable contacts structure; 33. Fixed contact points; 34. Movable contacts; 34a. Movable contact points; 35. Movable contacts; 35a. Movable contact points; 36. Contact spring; 36′. Contact spring for the first to fourth embodiment of the present invention EEEC; 36″. Contact spring for the fifth embodiment of the present invention EEEC; 36a. Receiving member; 36a′. Receiving member for the first to fourth embodiment of the present invention EEEC; 36a″. Receiving member for the first to fourth embodiment of the present invention EEEC; 37. Returning spring; 37′. Returning spring for the first to fourth embodiment of the present invention EEEC; 38. Stopper; 39. Guide plates in the movable contact support 32; 40. Guide grooves; 41. Middle section partition wall and guide groove; 42. Partition walls; 42a. Horizontal end walls; 43. Stoppers; 44. Windows for fitting the movable contacts 34, the contact springs 36 and the receiving member 36a; 44′. Windows for fitting the movable contacts 34, the contact springs 36′ and the receiving member 36a′ for the first to fourth embodiment of the present invention EEEC; 44″. Windows for fitting the movable contacts 34, the contact springs 36″ and the receiving member 36a″ for the fifth embodiment of the present invention EEEC; 45. Windows for the auxiliary contacts 12 & 13, the contact springs 36 and the receiving member 36a; 45′. Windows for the auxiliary contacts 12 & 13, the contact springs 36′ and the receiving member 36a′ for the first to fourth embodiment of the present invention EEEC; 45″. Windows for the auxiliary contacts 12 & 13, the contact springs 36″ and the receiving member 36a″ for the fifth embodiment of the present invention EEEC; 46. Grooves for inserting the supporting plates 10y; 47. Groove for interlocking with a parallel electromagnetic contactor; 48a. Cable; 48b. Cable; 48c. Cable; 49a. Cables; 49b. Cables; 50a. Cable; 50b. Cable; 50c. Cable; 50d. Cable; 50e. Cable; 50f. Cable; 50g. Cable; 50h. Cable; 50i. Cables; 50j. Cables; 51. Guide grooves; 52. Central guide groove;
100. Inter pole partition walls; 101. Side wall; 102. Side wall; 103. Movable contacts support; 103a. Heart shaped channel or latching groove; 103b. Window in the slider projection 103c; 103c. Slider of the movable contacts support 103; 103d. Guide groove; 103e. Socket for screw 118; 103f. Slider stepped cut section; 103g. Outer end of the slider 103c; 103h. Free end of the slider 103c; 103i. Middle surface of the movable contacts support 103 from which slider 103c is projected; 103j. Heart shaped island;
Xₐ. Inclined and curved groove;
X_{b}. Inclined and curved groove;
X_{c}. Inclined and curved groove;
X_{d}. Inclined and curved groove;
\textcircled{A}. Top edge of the inclined surface Xₐ;
\textcircled{B}. Top edge of the inclined surface X_{b};
\textcircled{C}. Top edge of the inclined surface X_{c};
\textcircled{D}. Top edge of the inclined surface X_{d};
\textcircled{a}. Lower end of the inclined surface X_{b};
\textcircled{b}. Lower end of the inclined surface X_{c};
\textcircled{c}. Lower end of the inclined surface X_{d};
\textcircled{d}. Lower end of the inclined surface Xₐ;
104. Screw; 104a. Hole for fitting the screw 104; 104′. Screw; 104′a. Hole for fitting the screw 104′ 105. Front top surface of the upper body casing U1; 105a. Window in the top surface 105; 106. Front bottom surface of the upper body casing U1; 106a. Window in the bottom surface 106; 107. Connecting plates; 108. Central guide groove for the movable contacts support 103; 108b. Bottom surface/wall of the guide groove 108; 108ba. Window in the bottom surface 108b; 108c. Gap; 108t. Top surface/wall of the guide groove 108; 108ta. Steps in the top wall 108t; 108tb; Open space or window; 109. Biasing spring; 110. Stoppers; 111. U shaped partition wall; 111a. Plate connecting plates 108t; 112. Projection in the top surface 108t of the guide groove 108; 113. Guide groove; 114. Tie bar; 115. Stopper metal pin; 115a. Stopper metal pin body bent at two ends; 115b. Rings attached at two bent ends 115a of the metal pin 115; 116. Connector for attaching external movable contacts structure; 116a. Hole; 117. Latching member or driving member in the form of bent stiff wire (metal pin); 117a. Elongated body portion of the member 117; 117b. Drive end pin of the latching member 117 slidable engaging in the groove 103a; 117c. Non drive end pin of the latching member 117, vertically rockably retained by the hole 119 and slidable in the groove 103d; 117d. Small elongated body portion of the member 117 coupled in the system by the spring 109; 117e. Vertical body portion of the driving member 117; 118. Screw; 119. Hole in the projection 112; 120. Movable contacts support assembly comprising of the movable contacts support 103, connector 116 and the screw 118; 121. Partition walls; 121a. Edge of the top partition wall 121;
200. Central guide groove for the movable contacts support 103; 200b. Bottom surface of the guide groove 200; 200ba. Window in the bottom surface 200b; 200c. Gap; 200t. Top surface of the guide groove 200; 200ta. Steps in the top wall 108t; 200tb. Open space; 201. Projection in the top surface 200t; 202. Pin-Lever; 202a. Lever arm; 202b. Pin; 202c. Head; 202d. Hole in the head 202c; 203. Thumb screw; 203x. Smooth upper part of the screw 203; 203y. Threaded lower part of the screw 203; 203a. Hole for fitting the thumb screw 203; 204. Conical compression spring;
300. Front end upper outer wall of the outer body casing U3 and U4; 300′. Front end lower outer wall of the outer body casing U3 and U4; 300a. Cover; 300b. Screw;
500. Front end upper and lower outer horizontal walls of the outer body casing U5; 501. Side wall; 502. Side wall; 503. Movable contacts support; 503a. Cylindrical projection; 503b. Cylindrical projection; 503c. Cylindrical projection; 503d. A series of radially spaced outwardly projecting lugs in the cylindrical projection 503b; 503da. First teeth; 503db. Second teeth; 503dc. Third teeth; 503dd. Fourth teeth; 503ea. First lip; 503eb. Second lip; 503ec. Third lip; 503ed. Fourth lip; 503f. Threaded end of the cylinder 503c; 503g. Middle face of the movable contacts support 503; 503k. A series of longitudinally extending deep slots defined between the lugs 503d; 504. Spring; 505. Bushing; 505a. Inner body of the bushing 505; 505b. Outer body projection of the bushing 505; 505c. Edges of the outer bushing 505b; 506. Tubular latch element; 506a. Outer body of the tubular latch element 506; 506b. A series of equally distant ears; 506c. Downwardly projecting teethes; 506d. A series of radially spaced inwardly projecting lugs; 506da. First teeth; 506db. Second teeth; 506dc. Third teeth; 506dd. Fourth teeth (not shown in the Figure); 506e. A series of inwardly projecting lips; 506ea. First lip; 506eb. Second lip; 506ec. Third lip; 506ed. Fourth lip; 506f. Lower side opening in the latching element 506; 506g. Inner surface of top end opening 506i; 506h. Step; 506i. Top side opening in the latching element 506; 506j. Hollow tube; 506k. A series of longitudinally extending deep slots defined between the lugs 506d; 506m. Top circular edge of the tubular latch element 506; 507. Tubular latch actuating element; 507a. Outer surface of the latch 507; 507b. Inside opening in the latch 507; 507c. Lower end opening in the latch 507; 507d. Interiorly the annular lip; 507e. A series of spaced ears; 507f. A series of upwardly extending teeth; 508. Coupler; 508a. Threaded outer tubular surface; 508b. Threaded inner surface of the coupler; 508c. Square projection; 508d. Threaded socket for the screw 510; 509. Connector for external movable contacts support; 509a. Square projection; 509b. hole; 510. Screw; 511. Connecting plates; 512. Vertical partition walls; 513. Upper and lower horizontal partition walls of the central guide grooves 516; 514. Barrel in the central guide groove 516; 514a. A series of radially spaced inwardly projecting lugs; 514b. A series of longitudinally extending deep recess or slots; 514c. An inner longitudinally extending shallow recess or slot;
X₁, X₂, X₃, X₄, X₅. Position of the downwardly projecting teeth 506c with respect to the latch receiving means of the barrel 514 when the contactor is ON-OFF;
X₅, X₆, X₇, X₈, X₉, X₁′. Position of the downwardly projecting teeth 506c with respect to the latch receiving means of the barrel 514 when the contactor is operated for ON -OFF;
M₁. Upwardly projecting teeth; M₁′. Vertical sides; M₁″. Tapered sides; N₁. Upwardly projecting teeth N₁′. Vertical sides; N₁″. Tapered sides; L₁. Lips; L₁′. Lips; 514′. Slightly inclined tubular hollow portion of the barrel 514; 515. Movable contacts support assembly comprising of the movable contacts support 503, the coupler 508; the connector 509 and the screw 510; 516. Central guide groove for the movable contacts support assembly 515;

### DETAILS DESCRIPTION OF THE INVENTION

There are five embodiments disclosed in the present invention Energy Efficient Electromagnetic Contactor EEEC which are developed for use in various industries and houses for starting of pumps, motors, machines, electrical power loads etc. The Energy Efficient Electromagnetic Contactor EEEC, in the First to Fifth embodiments of the present invention, having two main parts which are different from the existing electromagnetic contactor EC. These parts are the upper body casing U1, U2, U3, U4 and U5 and the movable contacts support assembly 120 and 515 in their respective embodiments. All other parts used in this present invention EEEC is same as that used in the prior art electromagnetic contactor EC.

In start/stop button control system as described in the FIG. 21 used in the case of existing electromagnetic contactor EC, there are two push button P and Q used and one auxiliary contacts of the electromagnetic contactor EC are used for switching ON/OFF of power supply 1 to the load, whereas in motor control system described in the FIGS. 19 and 20 using the present invention EEEC, only one push button P is required and no auxiliary contact is required for switching ON/OFF of power supply 1 to the load.

So, the upper body casings U1, U2, U3, U4 and U5 of the First, Second, Third, Fourth and Fifth embodiments of the present invention EEEC is different, novel and inventive in step compared to the existing upper body casing U of the existing electromagnetic contactor EC. The movable contacts support assembly 120 used in the First, Second, Third and Fourth embodiments and the movable contacts support assembly 515 used in the Fifth embodiment of the present invention EEEC are different, novel and inventive in step from the existing start/stop button motor control system using electromagnetic contactor EC. The mechanism used for keeping the EEEC in a state is different, novel and inventive in step compared to the mechanism of the existing EC. The start/stop button control system required in the present invention EEEC is different, novel and inventive in step from the existing start/stop button control system for the EC. Also in the present invention EEEC no continuous power to the operating coil 4 is required to keep main contacts in closed condition. Only a very short period power is required to attract the movable iron core 37 and it will remain in this state due to innovative and novel operating mechanism used in the present invention EEEC.

FIG.-19 describes the start/stop single push button switch control system in which the First, the Second, the Third or the Fourth embodiments EEEC11, EEEC12, EEEC13 or EEEC14 respectively is used.

FIG.-20 describes the start/stop single push button control system in which the Fifth embodiment EEEC2 is used.

FIG.-21 describes the start/stop double push button switch control system in which the existing electromagnetic contactor EC is used. FIG. 21 illustrates a well-known start/stop button control system using two push button switch, one push button NO switch P and other push button NC switch Q and also using one auxiliary contact 13 in switching ON and OFF circuit by the electromagnetic contactor EC.

### A. First Embodiment

FIGS.-1, 2a, 2b, 2c, 2d, 2e, 2e′, 2f, 2g, 2h, 2i, 2j, 4a, 4b, 4c, 6, 7, 8, 9, 10, 11, 12, 13, 17 and 18 describe the First embodiment of the present invention Energy Efficient Electromagnetic Contactor EEEC. Since many parts and some construction of the First embodiment is common to many parts and some construction of the existing electromagnetic contactor EC describes in FIGS.-22, 22a, 22b, 22c, 22d and hence are also used in describing the First embodiment of the present invention EEEC.

The First embodiment of the present embodiment is same as the existing electromagnetic contactor EC with changes in the upper body casing U and the movable contacts support 32 of the existing electromagnetic contactor EC. Also there are additional parts like the electromagnetic armature lifter Z1 and the pull type actuator solenoid Z2 in the First embodiment of the present invention EEEC which are not there in the existing electromagnetic contactor EC.

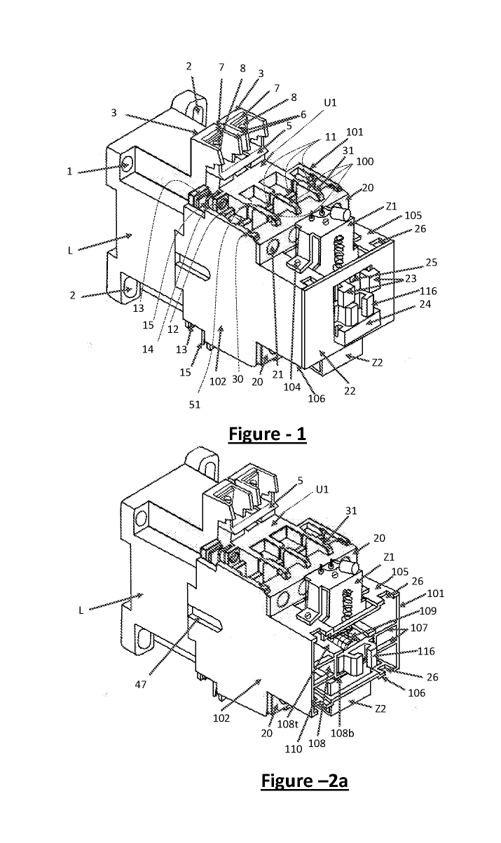

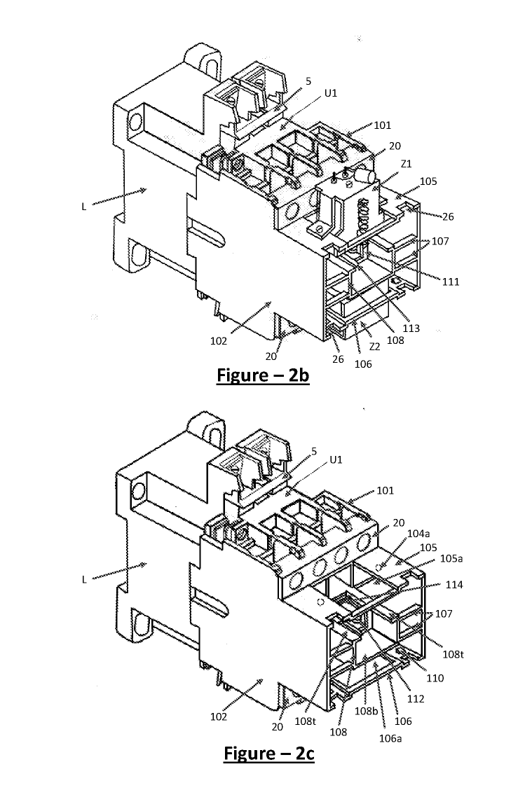

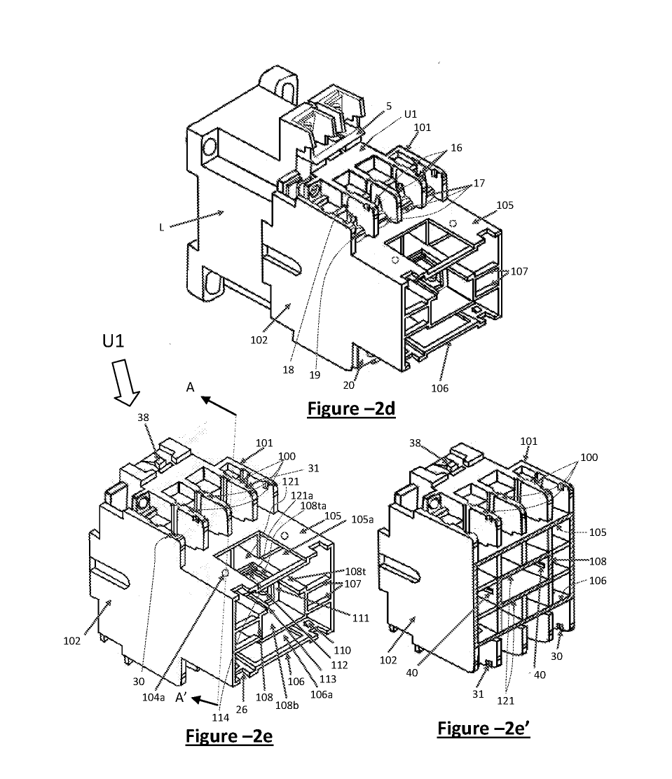

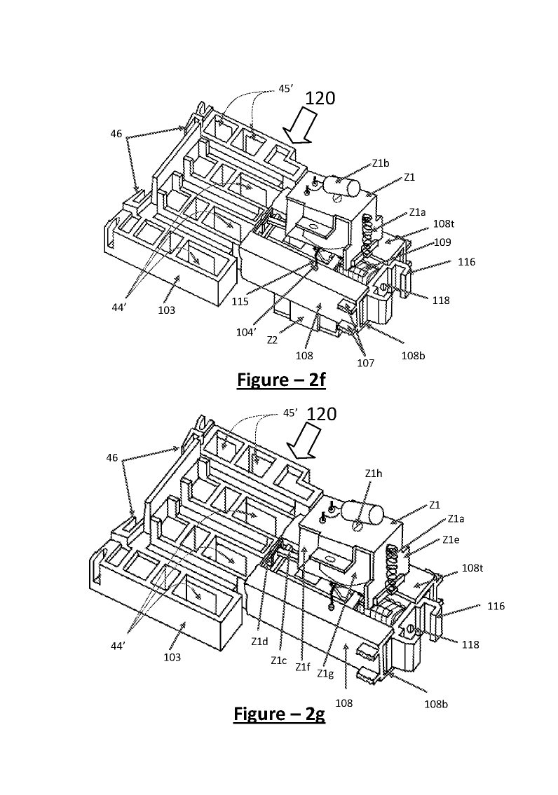

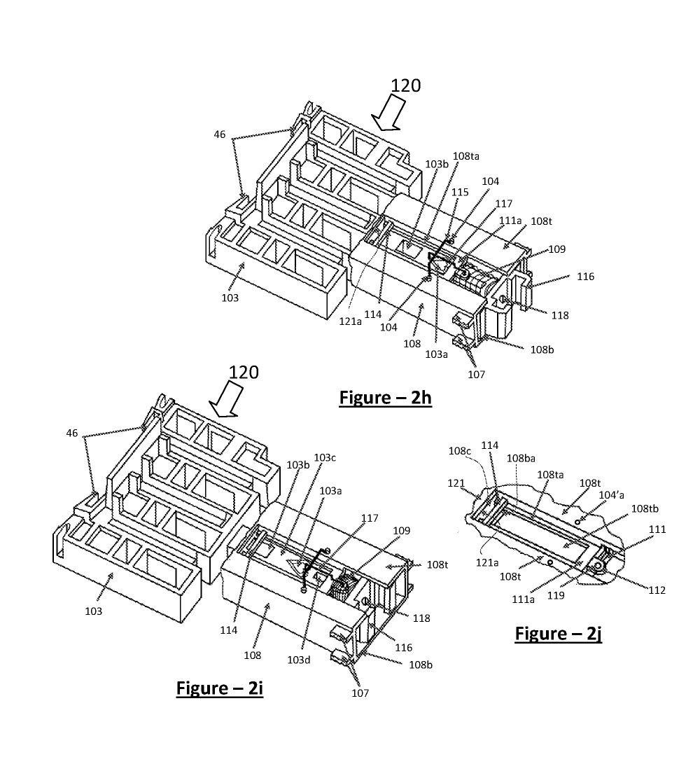

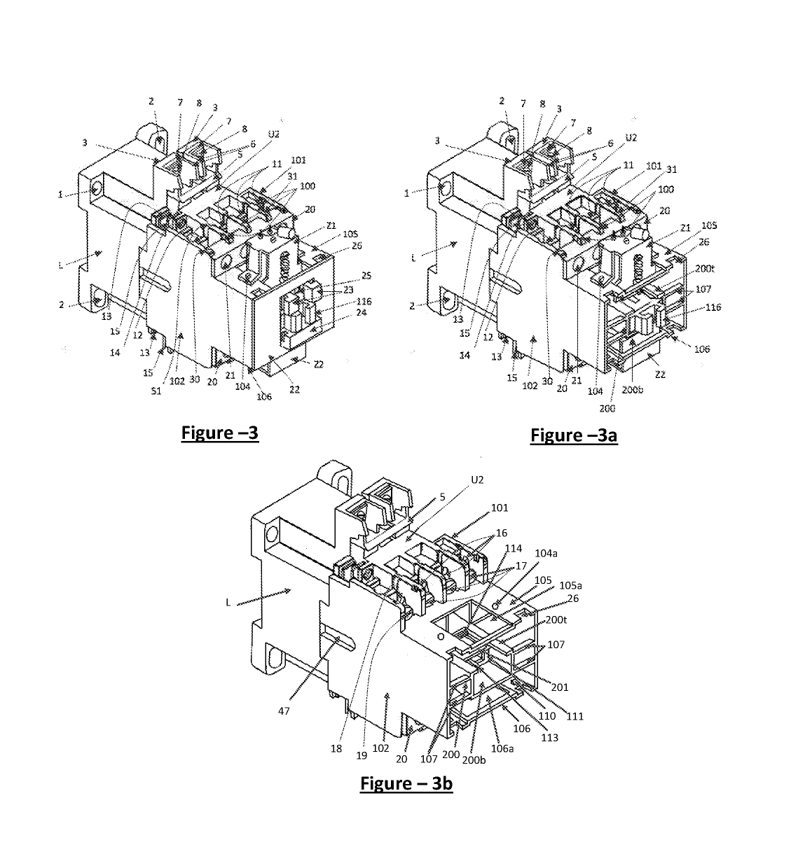

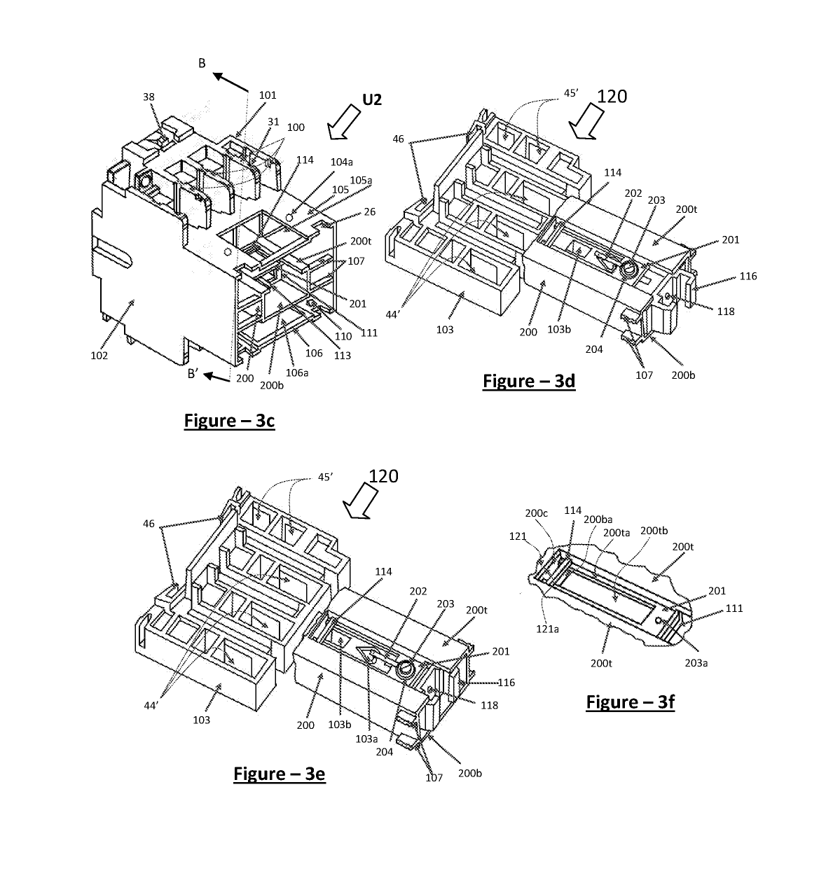

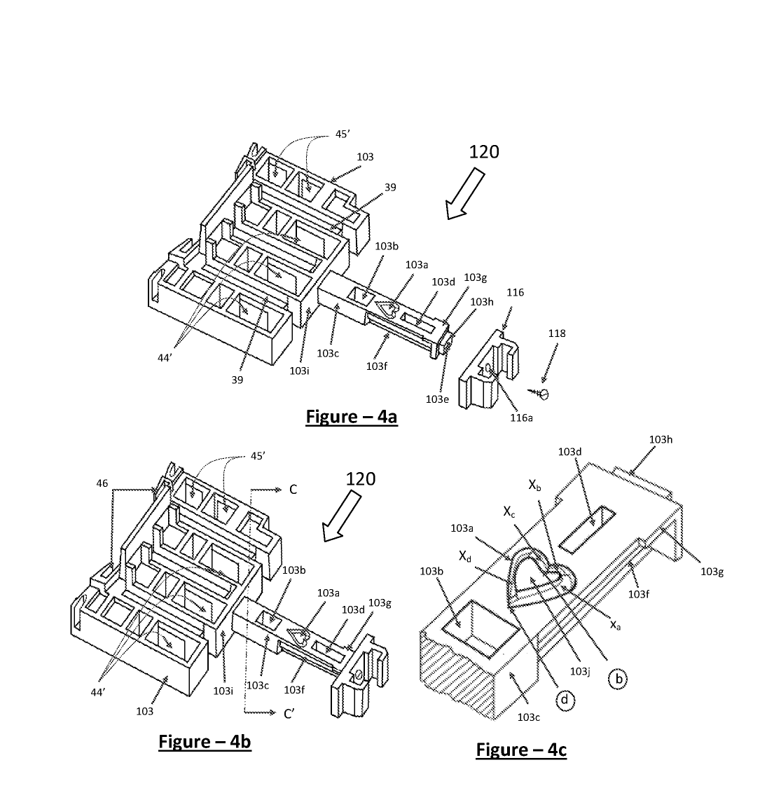

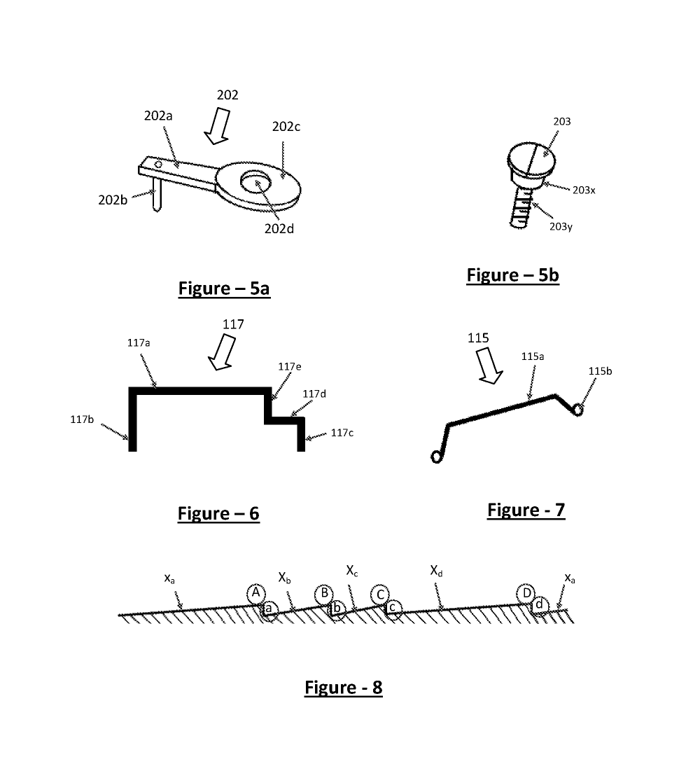

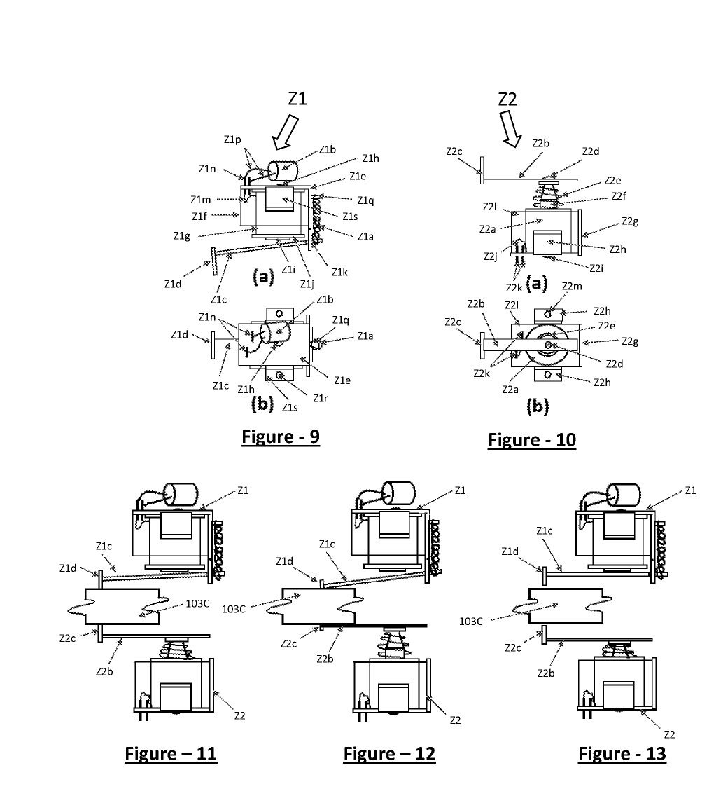

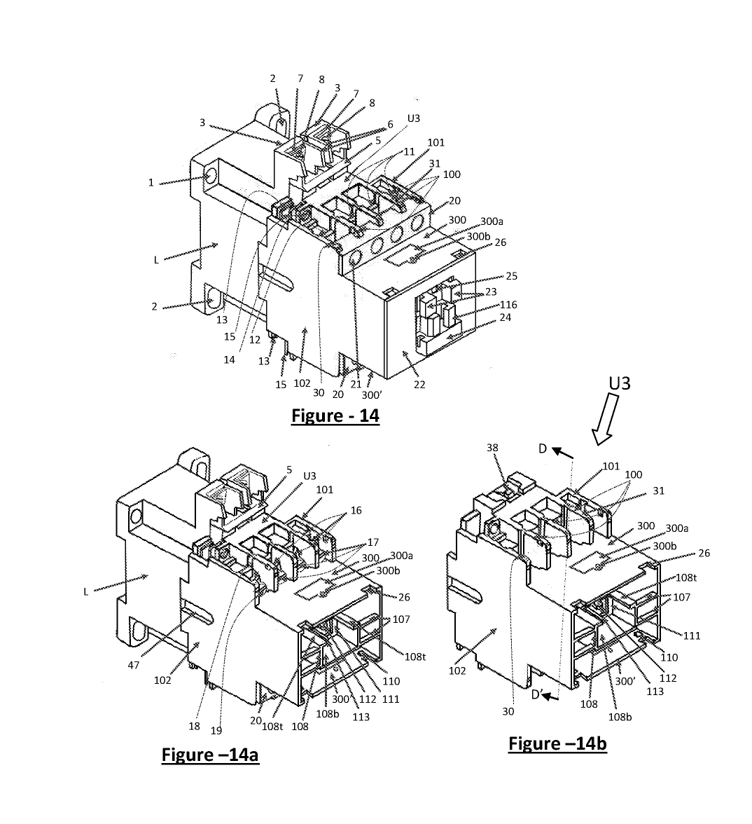

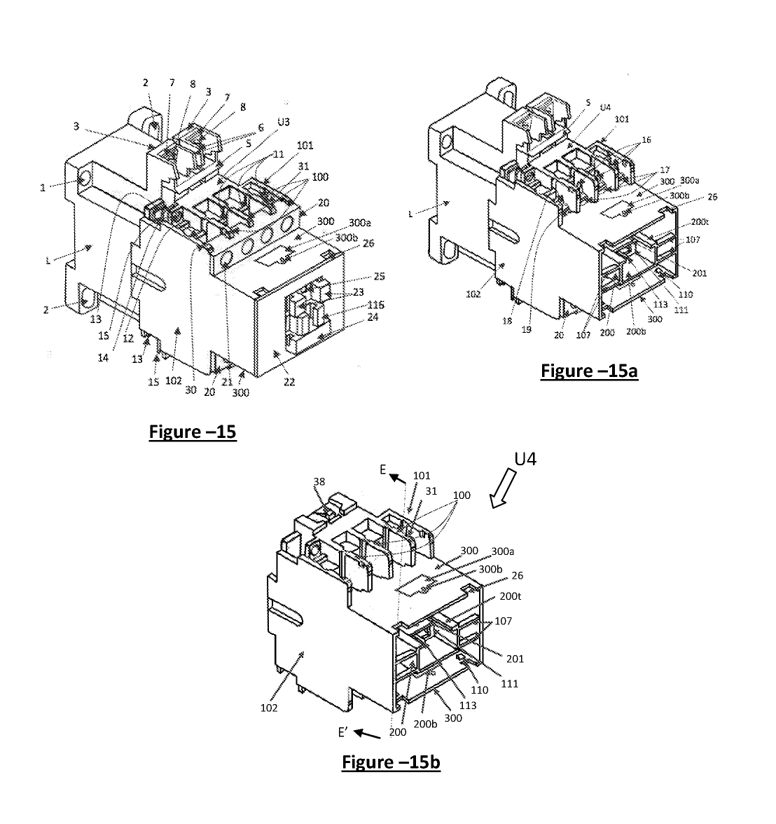

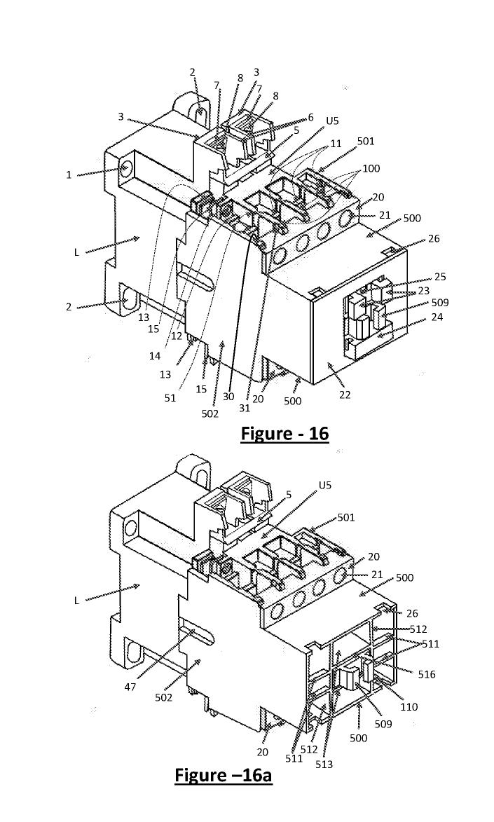

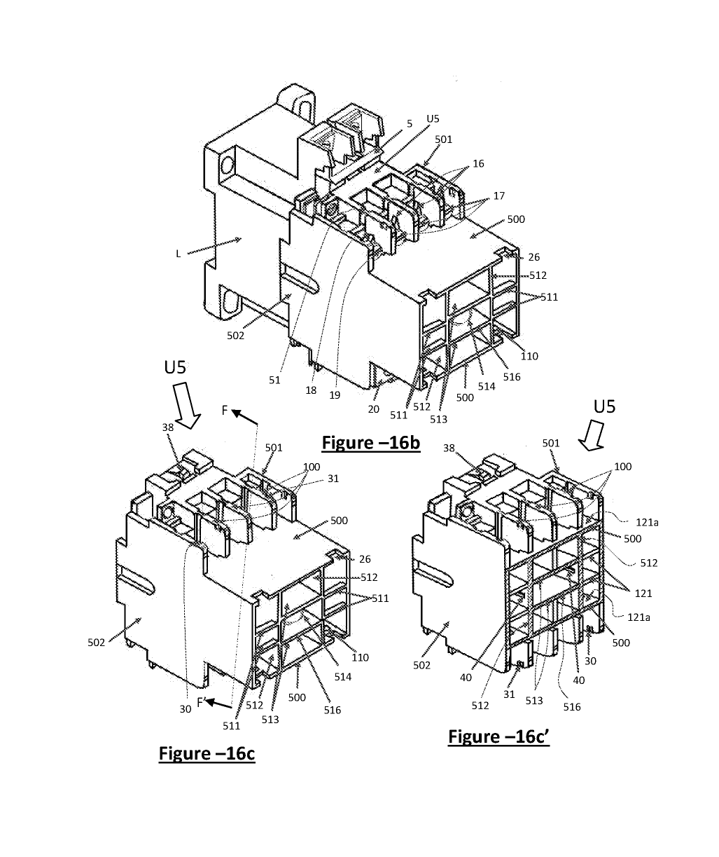

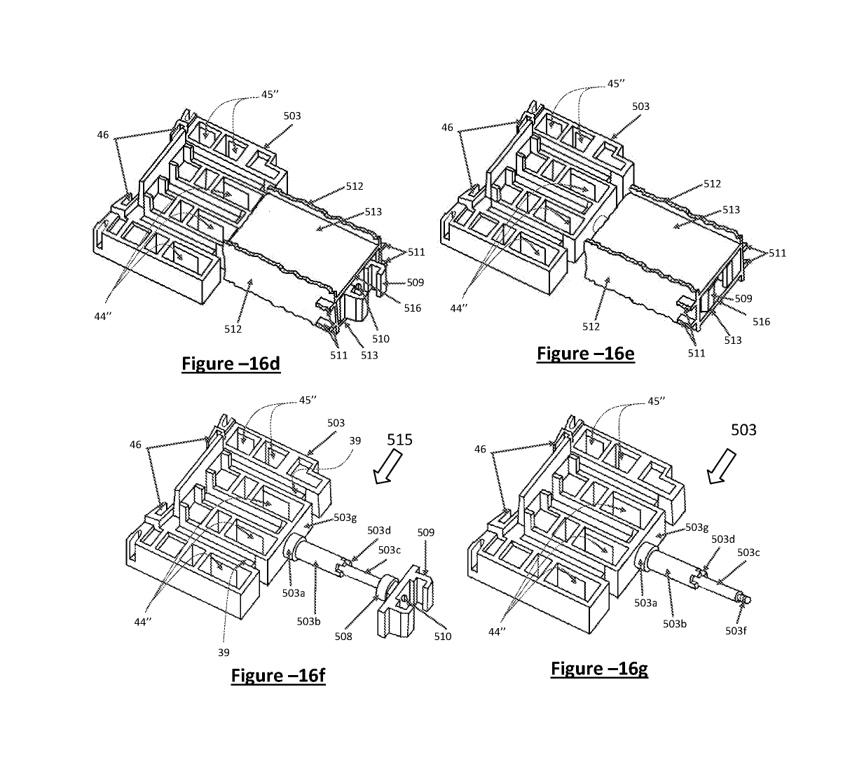

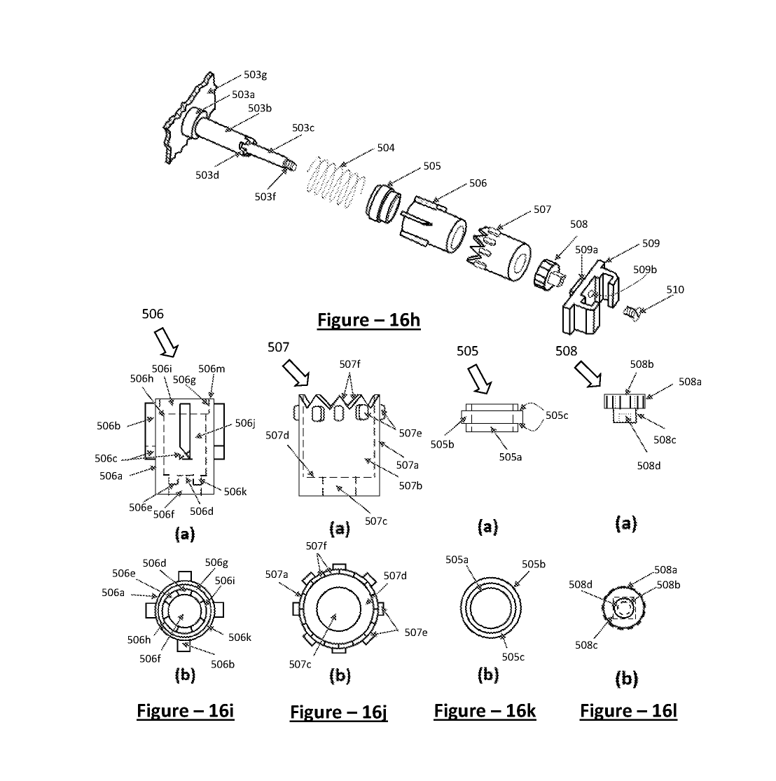

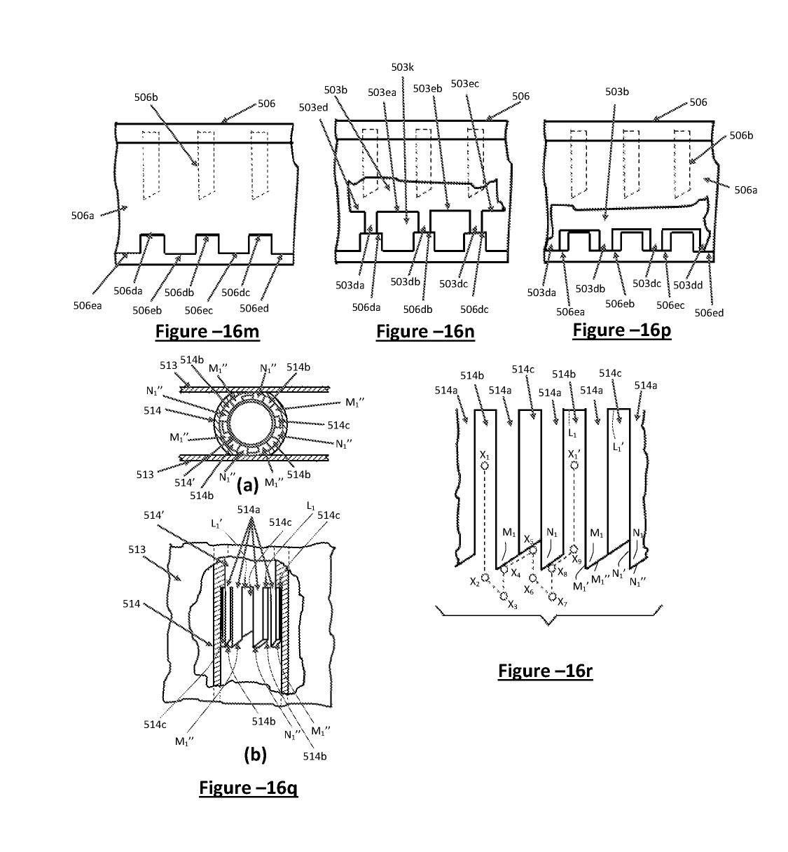

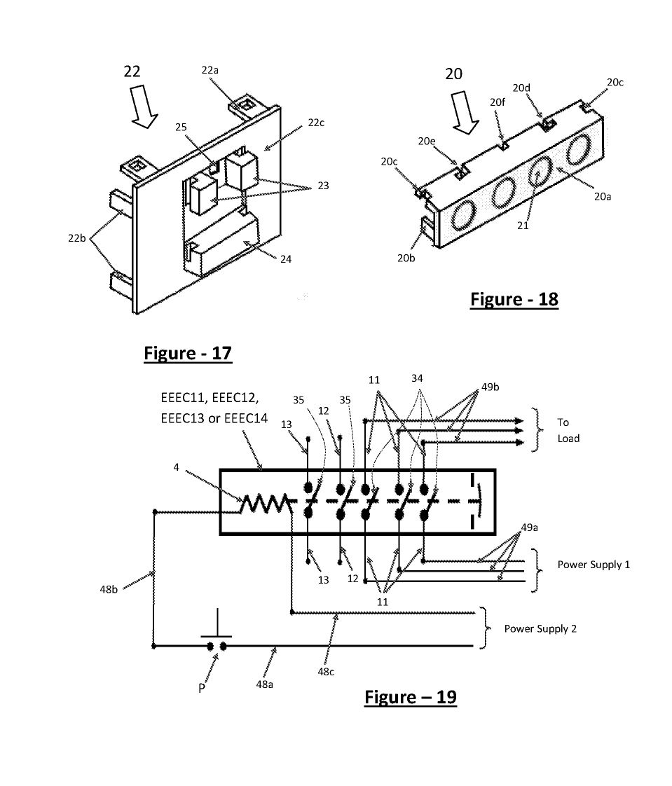

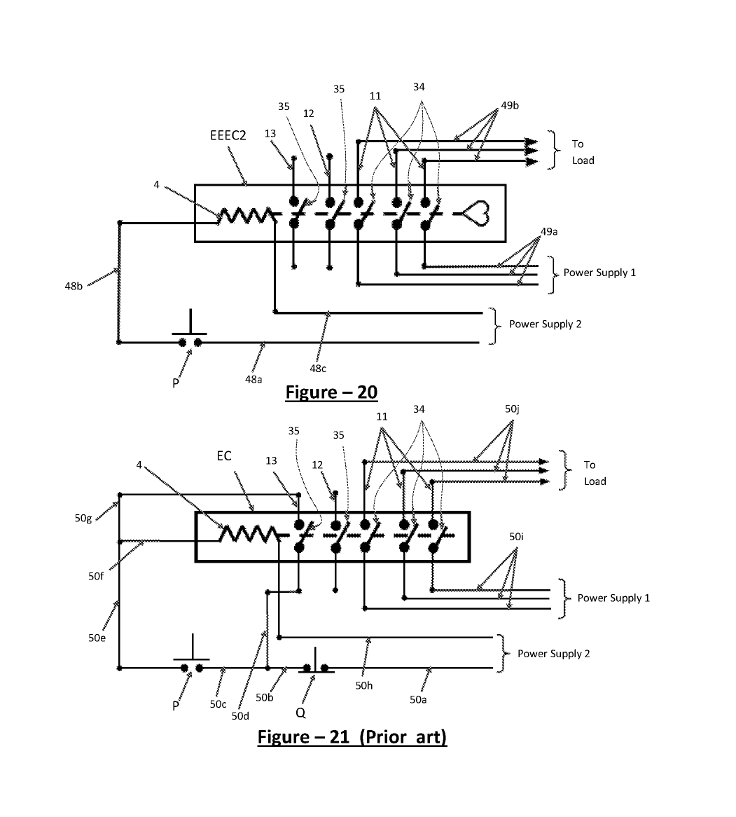

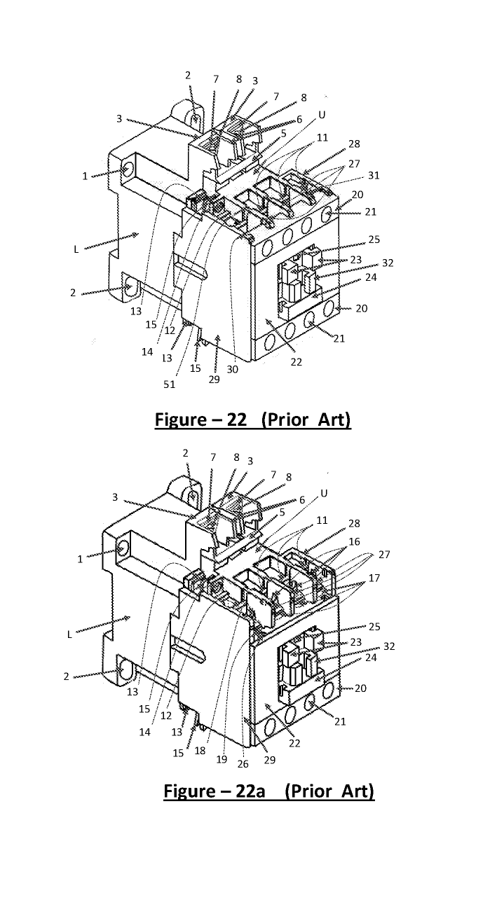

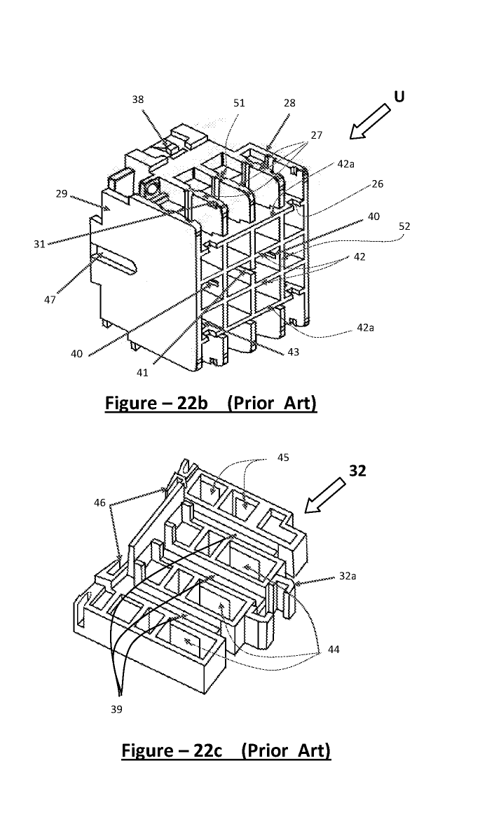

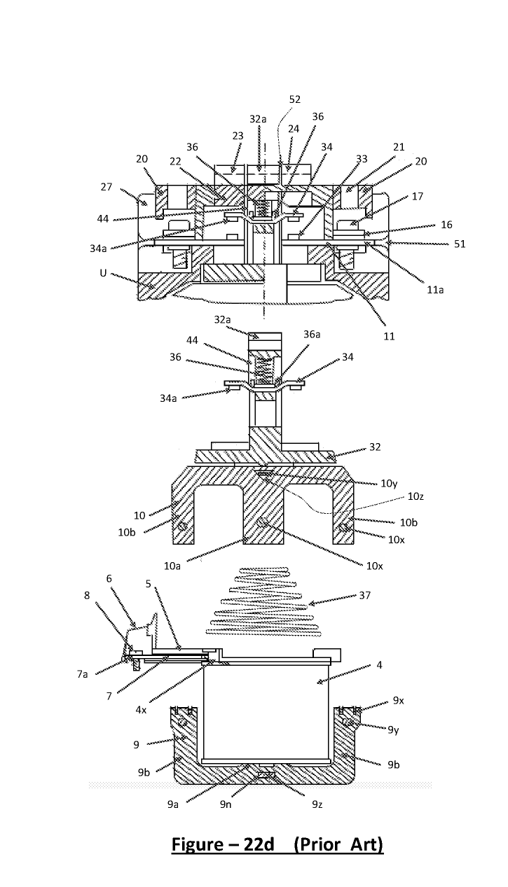

The upper body casing U1 shown in the FIGS.-1, 2a, 2b, 2c, 2d, 2e, 2e′, 2f, 2g, 2h, 2i, and 2j describes the upper body casing U1. FIG.-2e shows perspective view, FIG.-2e′ shows imaginary cut plane sectional view and FIG.-2j shows cross sectional view of a small top portion of the top surface/wall 108t of the upper body casing U1. An upper body casing U1 is formed of synthetic resin or any other insulating material and has side walls 101 and 102. Partition walls 100 are provided between these side walls 101 and 102 and acts like insulating wall between two adjacent contacts. These insulating partition walls 100 also defined insulating sections or domains, the number of which corresponds to the number of poles. There is steps 108ta, connecting plate 111a connecting two ends of the top plates 108t and projection 112 in the same plane. The tie bar 114 connects ends of the step 108t near the edge 121a with the suitable gap 108c touching the plane of the step 108ta in which the stopper plate Z1d is placed freely touching the top surface of the slider 103c and when the operating coil 4 is energized the plate Z1d slide on the surface of the slider 103c and falls in the window 103b. There is an opening 108tb in the top surface 108t for placing the driver member 117. The imaginary plane cut section lower part view of the upper body casing U1, U2, U3 or U4 shown in FIG. 2e′ is same as that of the upper body casing U of the prior art electromagnetic contactor EC shown in the FIG. 22b except a minor difference like there is no trapezoidal grooves 26, stoppers 43 and middle central section partition wall and groove 41 in the present invention EEEC for that part of the upper body as shown in the FIG.-2e′. Main fixed contacts 11 having screw terminals 11a and fixed contacts point 33 are provided between the side wall 101 and the neighboring partition walls 100 and between the respective partition walls 100, as shown in the FIGS. 1 to 2d. The upper portion of the movable contacts support assembly 120 is guided to be slidable on the axial line of the upper body casing U1 in the central guide groove 108 formed between the fixed contacts 11. The contact guide groove 108 is designed for accommodating slider 103c to freely slide inside the groove 108.

The movable contacts support 103 as described in the FIG.-4a is formed with windows 44′ extending in the longitudinal direction of the main fixed contacts 11 and windows 45′ extending in the longitudinal direction of the auxiliary contacts 12 and 13 and the slider 103c. In the window 44′, a movable contact 34 including contact points 34a for bridging (closing) and releasing (opening) the fixed contact points 33 of the main fixed contacts 11 is supported together with a contact spring 36′ and a receiving member 36a′. The location of the contact spring 36′ and the receiving member 36a′ is similar to that of the contact spring 36 and 36a. The property of the spring 36′ is different than the property of the spring 36. In windows 45′, a movable contacts 35 including contact points 35a for bridging (closing) and releasing (opening) the fixed auxiliary contact points 12b and 13b of the auxiliary fixed contacts 12b and 13b respectively is supported together with a contact spring 36 and a receiving member 36a. The movable contacts support 103 is linked to a movable iron core 10 and coupled to it by a supporting plate 10y inserted in grooves 46 of the movable contact support 103 and a window 10z in the movable iron core 10 at its bottom side. The movable iron core 10 is attracted or released from a driving electromagnet accommodated in \he lower body casing L i.e. the stationary iron core 9 attracts movable iron core 10 when the operating coil 4 is energized. The slider 103c protrudes from the middle surface 103i of the movable contacts support 103 in axial direction parallel to axial line. There is one window 103b in the slider 103c in longitudinal direction to accommodate the stop plates Z1d and Z2c when the movable contacts support assembly 120 is attracted. There is one heart shaped channel or latching groove 103a and one groove 103d in the top surface in the slider 103c. The movable contacts support 103 is made of insulating material and is adapted to slide into and out of the guide groove 108 in the upper body casing U1, there by engaging/disengaging the appropriate switch contacts within. There is similarity in design between the movable contacts support 103 upto the middle surface/wall 103i and the movable contacts support 32 of the existing electromagnetic contactor EC except dimensional difference in windows 44 and 45 and the middle guide plate 39 and the connector 47. The slider stepped cut section 103f slides over the guide groove 113.

The heart shaped channel 103a is having two long inclined groves Xₐ and X_{d} combined forming bigger V shape and two short inclined groves X_{b} and X_{c} combined forming small V shape as described in the FIGS.-4a, 4b, 4c and 8. The bottom end of the one end 117b of the driving member or lathing member 117 traverse the path along the inclined curved groove Xₐ, X_{b}, X_{c} and X_{d}. There are two stable position \textcircled{b} and \textcircled{d} of the drive end pin 117b of the driving member 117.

As described in the FIGS.-1, 2a, 2f, 2g, 2h, 2i, 2j, 4a, 4b, 4c the movable contacts support 103 having all its movable contacts 34 and 35 attached properly to their windows 44′ and 45′ respectively by the springs 36′ and receivers 36a′ is inserted in the upper body casing U1 such that the slider 103c enters first in the guide groove 108. The upper body casing U1 is pressed and fixed on the lower body casing L. Then the biasing spring 109 is inserted in the slider 103c upper portion available in the guide groove 108 away from the partition wall 111. After this the connector 116 is connected to the free end 103h of the slider 103c by the screw 118.

As described in FIGS. 2h and 2i, the movable contacts support 103 is adapted to be moved to two operative positions and is normally biased to its outer position by the returning spring 37′ and the suitable biasing spring 109 when the operating coil 4 is de-energised. The biasing spring 109 is inserted in the outer end 103g of the slider 103c, its one end is inserted in the guide groove 113 at the bottom and the small elongated body position 117d at the top and its other end is stopped by the connector 116 attached to the slider 103c by the screw 118. The spring 109 partly overlapped the small elongated end 117d of the driver member 117 in such a way that it freely allowed free movement of the drive end pin 117b into the heart shaped channel 103a about the non drive end pin 117c inserted in the hole 119. The heart shaped channel 103a is inclined and stepped to provide positive snap action switching and means are provided to impart a seesaw motion to the driving member 117, thereby to move the drive pin 117b of the driving member 117 into positive camming engagement with the stepped upper surface of the channel 103a. The drive pin 117b is guided by the side wall of the heart shaped channel 103a.

As described in the FIGS.-2h and 2i, the driving member or latching member 117 is vertically placed above the heart shaped channel 103c and the hole 119. The drive pin 117b end of the driver member 117 is kept in the heart shaped channel 103a and free to follow stepped inclined paths Xₐ, X_{b}, X_{c} and X_{d} in one direction only. The drive end pin 117b can not trace the reverse path X_{d}, X_{c}, X_{b} and Xₐ. The non drive end pin 117c is inserted in the hole 119 in the projection 112 in the plate 111a pivotally mounted and its lower end engaged with the groove 103d which act like a guide groove for this end 117c of the driver member 117. The stopper pin 115 as described in the FIG.-7 is fixed in the top surfaces 108t by the screw 104′ and its longer section just above the elongated body portion 117a of the member 117 acts like a preventer for the drive end pin 117b from coming out of the heart shaped channel 103a.

The movable contacts support assembly 120 as described in the FIG.-4a, 4b and 4c comprising of the movable contacts support 103 attached to it the connector 116 by the screw 118.

A stationary iron core 9, which is E-shaped similar to the E-shaped movable iron core 10, is provided with a supporting plate 9z inserted inside its window 9n and covered at their ends with elastic bodies 9m (not shown in the figure), is placed inside the lower body casing L. Shading coils 9x are provided at top end of the outer legs 9b. Individual laminated steel/iron cores are stacked and made a single unit of the stationary iron core 9 by using rivets 9y. Individual laminated steel/iron cores are stacked and made a single unit of the movable iron core 10 by using rivets 10x. The movable iron core 10 is coupled to bottom of the movable contacts support 103 by inserting the supporting plate 10y in the triangular window 10z of the core 10 and the grooves 46 of the support 103.

A bobbin 5 may include an upper plate, a lower plate, a coil 4 accommodation portion, two terminal strips 7 accommodation portion and the top plate should be able to accommodate lower portion of the returning spring 37′. The bobbin coil 4 is placed in the central leg 9a of the stationary iron core 9.

The operating coil 4 is wound around the bobbin 5, and the bobbin 5 is fixed and coupled to one side of the lower body casing L and the coil accommodation portion is partly inserted in the central leg 9a of the core 9 which is also central portion of the lower body casing L. The terminal strips 7 fixed in the bobbin 5. Terminals 4x of the operating coils are connected to the terminal strips 7. Protrudes 6 in the bobbin 5 is provided for insulating wall between two terminal strips 7 of the coil 4.

The upper body casing U1 is configured to cover the lower body casing L and coupled with it.

The returning spring 37′ similar to the returning screen 37 is provided at the upper plate of the bobbin 5 and central leg 10a of the movable core 10 is inserted in the upper end of the returning spring 37′. The bottom surface of the returning spring 37′ is placed above he top surface of the bobbin 5 concentric to the axis of the coil 4. The movable contacts support 103, coupled to the movable contacts 34 and 35, coupled to the movable iron core 10 is placed inside the guide groove 108 of the upper body casing U1. The upper body casing U1 is pressed against the lower body casing L and covered and locked. The fixed contacts 11, 12 and 13 are inserted in their respective grooves 51. Terminal washers 16 are inserted in terminal screws 17 and the terminal screws 17 are screwed in the screw terminals 11a of the fixed contacts 11. Terminal washer 18 is inserted in terminal screw 19 and the terminal screw 19 is screwed in the screw terminal 12a of the auxiliary fixed contact 12. Terminal washer 15 is inserted in terminal screw 14 and the terminal screw 14 is screwed in the screw terminal 13a of the auxiliary fixed contact 13.

Top cover 22 is fixed to top surface, in axial direction, of the upper body casing U1 and terminal covers 20 are fixed above the fixed terminals 11 and 12 end.

The electromagnet armature lifter Z1 as shown in the FIGS.-1, 2a, 2b, 2f, 2g, 9, 10, 11, 12 and 13 comprises of the operating coil Z1g wound around the core Z1i and bobbin Z1j fitted to the magnetic iron structure Z1e by the screw Z1h, the armature returning spring Z1a is attached to one end of the armature Z1c hinged at the hinge Z1k to the yoke Z1e and the projection Z1g to help in returning the armature Z1c to its original position, the two terminals Z1m of the operating coil Z1g is connected to the two terminals Z1n insulated and fitted in the yoke Z1e and the terminals Z1n is also connected to the two terminals Z1p of the capacitor Z1b, the stoper plate Z1d is connected to the armature Z1c, a cover Z1f is used to cover the coil Z1g, the side plates Z1s of the yoke Z1e is having holes Z1r for fitting it in the the upper body casing U1 and U2 by the screws 104 of the First and Second embodiment of the present invention respectively. The capacitor Z1b is connected parallel to the coil Z1g and function like a time delay switch in which the armature Z1c does not return to its original position immediately but it takes some time and there is delay between termination of power to the operating coil Z1g and the release of the armature Z1c once attracted i.e. due to presence of the capacitor Z1b, even after deenergization of the operating coil Z1g, the armature Z1c does not immediately disengaged and restored its original position. There is always a time delay between termination of the power to the operating coil Z1g and release of the armature Z1c. When a voltage is applied to the terminals Z1n, to which both the capacitor Z1b and the Coil Z1g are connected parallely get charged and the armature Z1c gets attracted resulting in to lifting up of the stopper plate Z1 d. When the voltage is terminated to the the terminals Z1n, the armature Z1c released after some time and the stopper plate Z1d touches the surface of the slider 103c.

The pull type actuator solenoid Z2 as shown in the FIGS.-1, 2a, 2b, 2f, 9, 10, 11, 12 and 13 comprises of the solenid coil Z2a fitted to the magnetic iron structure or yoke Z1e by the screw Z2i, the armature returning spring Z2e is inserted in the upper side of the armature Z2f and compressed between the top surface of the coil Z2a and bottom surface of the lever arm Z2b, the armature Z2f is free to move in axial direction of the solenoid coil Z2a, the two terminals Z2j of the operating coil Z2a is connected to the two terminals Z2k insulated and fitted in the yoke Z2g, the lever arm Z2b is attached to top end of the armature Z2f by the screw Z2d near its one end and to other end the stopper plate Z2c is connected, a cover Z2l is used to cover the solenoid coil Z2a, the side plates Z2h of the yoke Z2g is having holes Z2m for fitting it in the the upper body casing U1 and U2 by the screws 104 of the First and Second embodiment of the present invention. The solenoid coil is having time delay property due to which the armature Z2f and hence the lever arm Z2b does not return to its original position immediately but it takes some time and there is delay between termination of power to the coil Z2a and the release of the armature Z2f once attracted. There is always a time delay between termination of the power to the solenoid coil Z2a and release of the armature Z2f When a voltage is applied to the terminals Z2k connected to the coil Z2a getting charged and the armature Z2f gets attracted resulting in to lifting down of the stopper plate Z2c. When the voltage is terminated to the terminals Z2k, the armature Z2f released after some time and the stopper plate Z2c touches the surface of the slider 103c.

Heart shaped—Driving Pin Operating Mechanism

When a voltage is impressed upon the terminals 7 of the operating coil 4 of the energy efficient electromagnetic contactor EEEC as described above, the stationary core 9 provided at lower portion gets magnetized and attracts movable iron core 10. As a result, the movable contacts support assembly 120 is attracted and lowered and the movable contacts points 34a touches the fixed contacts points 33 there by closing their electrical circuit i.e. bridging the fixed contacts 11, the returning spring 37′ and the biasing spring 109 gets compressed and the driving member 117 pivots anti clockwise and the drive end pin 117b traverses the longer inclined path Xₐ of the heart shaped channel 103a from the lower end d to the highest point A and then drop from A to the lowest point a of the shorter inclined path X_{b} and touching wall of the heart shape 103a as shown in the FIGS. 8 and 4c. The lowest end point d of the path Xₐ is one stable point for the drive end pin 117b and this is also the normal position of the present contactor EEEC when the movable contacts 34 not touching the fixed contacts 11 and the electrical circuit of the load is opened.

Now the voltage applied to the operating coil 4 is terminated, the attraction force between the stationary core 9 and the movable core 10 extinct and due to restoring force of the returning spring 37′ and the biasing spring 109, the movable core 10 will try to be separated from the stationary core 9 and the movable contacts support assembly 120 will try to move away from the fixed contacts 11 and hence the movable contacts 34 will try to be separated from the fixed contacts 11 which results in breaking electrical circuit but it will not happen because of the driving pin 117 and heart shape 103a operating mechanism. The driving member 117 pivots clockwise and the drive end pin 117b traverses the shorter inclined path X_{b} of the heart shaped channel 103a from the point lower point a to the highest edge s and then drop to the lowest point b of the shorter inclined path X_{c}. This point b is another stable position of the drive end pin 117b and this is also the position of the present contactor EEEC when the movable contacts 34 touching the fixed contacts 11 and the electrical circuit of the load remains in closed condition. When the power is fed to the operating coil 4 for a short moment the drive end pin 117b traverses from one stable point d to another stable point b and the fixed contacts 11 and the moving contacts 34 changes their state from open to close and will remain in close position even after disconnection of power supply to the operating coil 4. This also resulted into closing of auxiliary fixed contacts 12b and 13b with the movable contacts 35.

Now again the voltage is applied to the operating coil 4 of the energy efficient electromagnetic contactor EEEC as described above, the stationary core 9 provided at lower portion gets magnetized and attracts movable iron core 10. As a result, the movable contacts support assembly 120 is attracted and lowered and the movable contacts points 34a remain in contact with the fixed contacts points 33 and the returning spring 37′ and the biasing spring 109 gets compressed and the driving member 117 pivots clockwise and the drive end pin 117b traverses the shorter inclined path X_{c} of the heart shaped channel 103c from the lower end \textcircled{b} to the highest edge \textcircled{A} and then drop from \textcircled{A} to the lowest point 0 of the longer inclined path X_{d} as shown in the FIGS. 8 and 4c.

Now the voltage applied to the operating coil 4 is terminated i.e. switched off, the attraction force between the stationary core 9 and the movable core 10 extinct and due to restoring force of the returning coil 37′ and the biasing coil 109, the movable core 10 will try to be separated from the stationary core 9 and the movable contacts support assembly 120 will try to move away from the fixed contacts 11 and hence the movable contacts 34 will try to move away from the fixed contacts 11 which will result in breaking electrical circuit. The driving member 117 pivots anti clockwise and the drive end pin 117b traverses the longer inclined path X_{d} of the heart shaped channel 103a from the point lower point \textcircled{c} to the highest edge \textcircled{D} and then drop to the lowest point \textcircled{d} of the longer inclined path Xₐ. This point \textcircled{d} is stable position of the drive end pin 117b and this is also the position of the present contactor EEEC when the movable contacts 34 separated from the fixed contacts 11 and the electrical circuit of the load is open. When the power is fed to the operating coil 4 for a short moment the drive end pin 117b traverses from one stable point \textcircled{b} to another stable point \textcircled{d} and the fixed contacts 11 and the moving contacts 34 changes their state from close to open and will remain in open position even after disconnection of power supply to the operating coil 4. This also resulted into opening of the auxiliary fixed contacts 12b and 13b with movable contacts 35.

In the above paragraphs, describing operational features, it was presumed that the operating coil Z1g of the electromagnet armature lifter Z1 and the solenoid coil Z2a of the Pull type actuator solenoid Z2 are in energized state.

The properties of the returning spring 37′, the biasing spring 109 and the contact spring 36′ and the dimention of the windows 44′ and 45′ in the movable contacts support 103 should be such that to meet the above operational requirement of the first embodiment EEEC11 of the present invention the Energy Efficient Electromagnetic Contactor EEEC.

### Interlocking of Electromagnetic Armature Lifter Z1 and Pull Type Actuator Solenoid Z2

When the operating coil Z1g of the armature lifter Z1 and the solenoid coil Z2a of the pull type actuator solenoid Z2 are in de-energised state the stopper plate Z1d and Z2c respectively touches top and bottom surface of the slider 103c as shown in the FIG-11. When the operating coil 4 of the EEEC11 is energised the electrical contact closes i.e. fixed contacts and movable contacts closes and the movable contact assembly 120 pulled by the operating coil 4 due to electromagnetic force and the stopper plate Z1d and Z2c slides over upper and lower surface respectively of the slider 103c and finally fall in the window 103b. As long as this condition prevailed the electromagnetic contactor EEEC11 will remain in closed condition irrespective of energization or de energization of the operating coil 4 as shown in the FIG-12.

To open the contacts of the EEEC11 from closed position, both the armature lifter Z1 and the pull type actuator solenoid Z2 are to be in energised state first as shown in the FIG-13 which results into attraction of the armature Z1c and Z2b respectively as shown in FIG-13 resulting into lifting of the stopper Z1d and Z2c respectively. Now voltage is applied for a moment to the coil 4 then the closed contacts will open as described previously.

The interlocking mechanism is such that as long as the power supply to both the coil Z1g and Z2a are fed, the momentary power supply to the operating coil 4 will first pull and then release the movable contacts assembly 120 and depending upon the position of the driver pin end 117b in the heart shape 103a the electromagnetic contactor EEEC11 will remain in close or open condition. When the power supply to the coils Z1g and Z2a are disconnected and than the power is fed to the operating coil 4 the electromagnetic contact EEEC11 will change state from open to close but not from close to open.

### B. Second Embodiment

FIGS.-3, 3a, 3b, 3c, 3d, 3e, 2e′, 3f, 4a, 4b, 4c, 5a, 5b, 8, 9, 10, 11, 12, 13, 17 and FIG.-18 describe the Second embodiment EEEC12 of the present invention Energy Efficient Electromagnetic Contactor EEEC. Since many parts and some construction of the Second embodiment is common to many parts and some construction of the existing electromagnetic contactor EC describes in FIGS.-22, 22a, 22b, 22c, 22d and hence are also used in describing the Second embodiment of the present invention EEEC.

Second embodiment EEEC12 of the present invention is same as the First embodiment EEEC11 of the present invention with a minor changes in central guide groove 108 of the upper body casing U1 and minor changes in the driving member 117 and driving mechanism of the First embodiment EEEC11 of the present invention EEEC.

The upper body casing U2 of the second embodiment is same as the upper body casing U1 of the first embodiment with a minor difference in the connecting plate 111a. In this embodiment the connecting plate 201 with a hole 203a as described in the FIG.-3f is used. The central guide groove 200 is having the top surface 200t, the bottom surface 200b, the window 200ba in the bottom surface 200b, the open space 200tb and steps 200ta in the top wall. There is a screw hole 203a for fitting the screw 203.

The movable contacts support 103 and the movable contacts support assembly 120 of the First and the Second embodiment is same.

In this embodiment pin-lever 202 instead of the latching member 117 is used as a driver member. The lever 202 is fitted and coupled to the contact plate 201 by placing the spring 204 above the head 202c and inserting the screw 203 in the hole 202d and screwing it in the hole 203a of the connecting plate 201 as shown in the FIGS.-3d, 3e and 3f The pin 202 is free to rotate about the axis of the hole 202d. The conical compression spring 204 keep the lever 202 in pressed condition. The pin 202b riveted to the lever arm 20b and its bottom touches the heart shaped channel 103a and follow the same path as followed by the drive end pin 117b of the driver member 117 in the first embodiment of the present invention EEEC as described in the heart shaped driving pin operating mechanism in the first embodiment.

The pin 202b follow the same path as shown in the FIG.-8 as followed by the drive end pin 117b during the course of operation as described in the first embodiment.

The operation of the second embodiment EEEC12 is same as that of the first embodiment EEEC11.

### C. Third Embodiment

FIG.-14, FIG.-14a, FIG.-14b, FIG.-2h, FIG.-2i, FIG.-2j, FIG.-2e′, FIG.-4a, FIG.-4b, FIG.-4c, FIG.-6, FIG.-7, FIG.-8, FIG.-17 and FIG.-18 describe the Third embodiment EEEC13 of the present invention Energy Efficient Electromagnetic Contactor EEEC.

The third embodiment EEEC13 of the present invention is same as the First embodiment excluding the electromagnetic armature lifter Z1 and pull type actuator solenoid Z2 with a minor changes in front top surface 105 of the upper body casing U1 of the First embodiment of the present invention EEEC. The front top surface 300 of the upper body casing U3 of the third embodiment is described in the FIGS.-14, 14a and 14b having plane surface 300 and a cover 300a screwed to the plane surface 300 by the screw 300b. The front bottom surface 300′ is plane and do not have this cover 300a.

The operation of the third embodiment is same as that of the first embodiment without the electromagnetic armature lifter Z1 and pull type actuator solenoid Z2.

### D. Fourth Embodiment

FIG.-15, FIG.-15a, FIG.-15b, FIG.-3d, FIG.-3e, FIG.-2e′, FIG.-3f, FIG.-4a, FIG.-4b, FIG.-4c, FIG.-5a, FIG.-5b, FIG.-8, FIG.-17 and FIG.-18 describe the Fourth embodiment of the present invention Energy Efficient Electromagnetic Contactor EEEC. Since many parts and some construction of the Fourth embodiment is common to many parts and some construction of the existing electromagnetic contactor EC describes in FIG.-22, FIG.-22a, FIG.-22b, FIG.-22c, FIG.-22d and hence are also used in describing the Fourth embodiment EEEC14 of the present invention EEEC.

The fourth embodiment EEEC14 of the present invention is same as the second embodiment EEEC12 excluding the electromagnetic armature lifter Z1 and the pull type actuator solenoid Z2 of the present invention with a minor changes in front top surface 105 of the upper body casing U1 of the Second embodiment of the present invention EEEC.

The front top surface 300 of the upper body casing U4 of the fourth embodiment EEEC14 is described in the FIGS.-15, 15a and 15b having plane surface and a cover 300a screwed to the plane surface 300 by the screw 300b. The front bottom surface 300′ is plane and do not have this cover 300a.

The operation of the fourth embodiment EEEC14 is same as that of the second embodiment EEEC12 without the electromagnetic armature lifter Z1 and pull type actuator solenoid Z2.

### E. Fifth Embodiment

FIGS.-16, 16a, 16b, 16c, 16c′, 16d, 16e, 16f, 16g, 16h, 16i, 16j, 16k, 161, 16m, 16n, 16p, 16q, 16r, 17 and 18, in combination describe the Fifth embodiment EEEC2 of the present invention Energy Efficient Electromagnetic Contactor EEEC. Many parts and some construction of the Fifth embodiment is same as that of the third embodiment EEEC13 except upper body casing U5 and upper portion of the movable contact support assembly 515 and other operational parts and operational mechanism. The fifth embodiment EEEC2 uses retraction-contraction operating mechanism instead of heart shaped-driving pin operating mechanism used in the first embodiment EEEC11. It uses electromagnetic force for retraction of the movable contacts assembly 515 having movable contacts 34, 35, contact springs 36″ and the receiver members 36a″ fitted in it.

The upper body casing U5 of the fifth embodiment EEEC2 of the present invention Energy Efficient Electromagnetic Contactor EEEC is similar to the upper body casing U3 of the third embodiment with a minor difference in front end upper and lower outer walls 500 and the central guide groove 516. Imaginary cut plane sectional view across imaginary sectional plane F-F′ of the upper body casing U5 as shown in FIG.-16c is similar to that shown in FIG.-16c′. The design of this cut sectional perspective view of the upper body casing U5 is similar in design of that shown in the FIG.-2e′. In the front end upper and lower wall 500 of the upper body casing U5 there is no windows 300a as it is in the upper body casing U3. The other main difference between the U3 and the U5 is there is no barrel, similar to 514, in the central guide groove 108 of the U3. The vertical partition walls 100 extended/protrudes outwardly in axial direction in the middle portion and named as vertical partition walls 512. The front end upper and lower outer walls 500 extended inwardly in axial direction upto the windows for inserting the fixed contacts 11 and the fixed contact 12. The middle horizontal partition walls 513 extends from the horizontal partition walls 513 in axial direction. The central guide groove 516 comprises the vertical partition walls 512 and the horizontal partition walls 513 in axial direction as shown in the FIGS.-16b, 16c and 16c′ and the barrel 514.

The movable contacts support 503 is shown in the FIGS.-16d, 16e, 16f, 16g and 16h. The perspective view of the movable contacts support assembly 515 is described in the FIG.-16f. The lower portion of the movable contact support 503 upto the middle face 503g is same as that of the movable contact support 103 upto its middle face 103i with a little dimensional changes in windows 44′ and 45′. There are coaxial cylinders 503a, 503b and 503c in series protrudes from the middle face surface 503g. The cylinder 503a protrudes from the middle surface 503g of the movable contacts support 503. The cylinder 503b protrudes from face of the cylinder 503a in axial direction having a series of radially spaced outwardly projecting lugs 503d in outer periphery near its opposite end. The cylinder 503c protrudes in axial direction from the cylinder 503b. The first, second, third and fourth teethes 503da, 503db, 503dc and 503dd respectively are of equal width and depth as shown in the FIG-16n and the FIG-16p. The first, second, third and fourth lips 503ea, 503eb, 503ec and 503ed respectively are of equal width and depth. The opposite end or free end 503f of the cylinder 503c is threaded for coupling the coupler 508. There are windows 44″ and 54″ for keeping the movable contacts 34, the receiving member 36a″ and the contact springs 36″. There are windows 44″ and 45″ in the movable contacts support for keeping the movable contacts 34 and 35 respectively the receiving member 36a″ and the contact springs 36″. The movable contacts 34 and 35 under the pressure of the contacts spring 36a″ is free to move in axial direction in the windows 44″ and 45″ respectively. The movable contacts 34 under the pressure of the contacts spring 36a″ is free to move in axial direction in the windows 45′.

The movable contacts support assembly 515 is shown in the FIGS.-16d, 16e, 16f, 16g, 16h, 16i, 16j, 16k and 161. The perspective view of the movable contacts support assembly 515 is described in the Figure-16f. The movable contacts assembly 515 comprises of the movable contacts support 503 attached to it the coupler 508 and the connector 509 screwed by the screw 510 in the coupler 508.

### Protraction—Retraction Operating Mechanism

Perspective view of the tubular latch element 506 is shown in the FIG.-16h. Front view and top view of the latch element 506 is shown in the FIG.-16i(a) and 16i(b) respectively. A series of radially spaced ears 506b extend outwardly from the upper portion of the latch element 506, and the bottom edge of the ears 506b are tapered so as to form the downwardly projecting teeth 506c. Outer surface of the latch element is tubular 506a. The inner surface near top 506g is projected inwardly in radial direction 506h and then projected in axial direction. A series of radially spaced inwardly projecting lugs 506d extend inwardly from the lower portion of the latch element 506. The hole 506f is near the bottom end and allow only the cylinder 503c to pass through it freely. The first, second, third and fourth teethes 506da, 506db, 506dc and 506dd respectively are of equal width and depth as shown in the FIG-16m. The first, second, third and fourth lips 506ea, 506eb, 506ec and 506ed respectively are of equal width and depth. The inner diameter of the tubular lath element hollow tube 506j is slightly greater than the cylindrical diameter of the cylinder 503b and the cylinder 503b is free to move inside the hollow tube 506j in axial direction. The teethes 503da, 503db, 503dc and 503dd of the cylinder 503b touches the teethes 506da, 506db, 506dd and 506de of the latch element 506 respectively and touches the lips 506ea, 506eb, 506ec and 506ed of the latch element 506 during one operation of ON and one operation of OFF respectively in the fifth embodiment EEEC2 of the present invention Energy Efficient Electromagnetic Contactor EEEC as shown in the FIGS.-16n and 16p respectively. During next ON operation the teethes 503da, 503db, 503dc and 503dd of the cylinder 503b touches the teethes 506db, 506dc, 506dd and 506de of the latching element 506 due to their rotation and axial movement. During next OFF operation the teethes 503da, 503db, 503dc and 503dd of the cylinder 503b touches the lips 506eb, 506ec, 506ed and 506ee of the latching element 506. During each operation the latch element 506 rotates one step ahead with respected to the latch actuating element 507 about its axis. The top cylindrical edge of the latch actuating element 506 touches the edge 505c of the outer body projection 505b and the inner body 505a of the bushing 505 is inserted from the top opening 506i of the latch element 506. The bushing 505 and the latching element 506 rotates about its axis during the operation of the present invention EEEC.

Perspective view of the tubular latch actuating element 507 is shown in the FIG.-16h. Front view and top view of the latch element is shown in the FIGS.-16j(a) and 16j(b) respectively. A series of spaced ears 507e extend outwardly from the top portion of the latch actuating element 507 and a series of upwardly extending teeth 507f are defined by the top edge of the element 507. The radially projecting ears 507e extend into and are longitudinally movable within the slots 514b and 514c defined in the barrel 514 section, but are restrained against rotation about its axis by the sides of the slots 514a defined in the barrel 514a section in the FIG.-16q and 16r. The tubular latch actuating element 507 is having interiorly the annular lip 507d further projected in axial direction in the hollow lower portion 507c of the element 507. The diameter of the tubular hollow portion 507 is slightly bigger than the cylindrical diameter of the cylinder 503c and allows free movement of the moving contacts support 503 assembly 515.

Perspective view of the bushing 505 is shown in the FIG.-16h. Front view and top view of the latch element is shown in the FIG.-16k(a) and 16k(b) respectively. The bushing 505 is having one inner body 505a and one outer body 505b having edges 506c on both ends.

Perspective view of the coupler 508 is shown in the FIG.-16h. Front view and top view of the coupler 508 is shown in the FIG.-16l(a) and 16l(b) respectively. The coupler 508 is having upper cylindrical portion having outer surface is axially threaded 508a and extended bottom portion square shaped 508c. There is threaded inner surface 508b in the cylindrical portion 508a for screwing it in the threaded outer surface 503f of the cylinder 503c. There is threaded inner surface 508d in the square protrudes 508c inserted in the square projection 509a of the connector 509 and fixed by using the screw 510 inserted in the threaded inner surface 508d through the hole 509b in the connector 509.

Interiority of the barrel section 514 as described in the FIGS.-16b, 16c, 16q(a), 16q(b) and 16r is formed as a latch receiving means including a series of radially spaced inwardly projecting lugs 514a and a series of longitudinally extending deep recesses or slots 514b defined between the lugs 514a. Each of the lugs 514a, is formed with an inner longitudinally extending shallow recess or slots 514c and lips L1 and L1′ are formed at the bottom of the slots 514b and 514c respectively. A pair of upward projecting teeth M₁ and N₁ are formed by notching the top of each lug 514a, the teeth M₁ and N₁ being of shallow tooth depth and having the tapered side M₁″ and N₁″ respectively, and the vertical sides M₁′ and N₁′ respectively. The barrel 514 touches the upper and lower walls 513 of the central guide groove 516 and is formed inside it in axial direction.

As described in the FIGS.-16, 16a, 16b, 16c, 16c′, 16d, 16e, 16f, 16g, 16h, 16i, 16j, 16k, 161, 16m, 16n, 16p, 16q, 16r, 17, 18, and 22d the movable contacts support 503 having all its movable contacts 34 and 35 attached properly to their windows 44″ and 45″ respectively by the springs 36″ and receivers 36a″. Then the spring 504, the bushing 505, the latch element 506 and then the latch actuating element 507 are inserted in the cylindrical projection 503c, 503b, 503a. The face of the spring 504 seats on the surface 503g and the other end seats against the edge 505c of the bushing 505. The perspective view of the bushing 505 is shown in the FIG-16h and front view and top view are shown in the FIG-16k(a) and 16k(b) respectively. The opposite edge 505c rest against the edge 506m of the latching element 506. The outer body 506a of the tubular latch element 506 is inserted inside the latch actuating element 507. The projecting teethes 506c of the element 506 seats against the upwardly teethes 507f of the element 507. Now the complete assembly is inserted in the barrel 514 in the central guide groove 516 of the upper body casing U5. The cylindrical projection 503c comes out of the hollow portion 507c of the latch actuating element 507. The coupler 508 is screwed in the threaded portion 503f of the cylindrical projection 503c. The upper surface of the coupler 508 touches the bottom surface near the hollow 507c. The ears 507e of the latch actuating element 507 are inserted in the slots 514b and the 514c of the barrel 514 and are free to move in longitudinal direction. The downwardly projecting teethes 506c of the latch actuating element 506 seats on the upwardly extending teethes 507f seats of the latch actuating element 507. The outer surface 506a of the lower portion of the element 506 is inserted inside the teethes 507f end of the element 507. The latch element 506 is free to move in longitudinal direction and free to rotates about its axis. The coupler 505 is free to move in longitudinal direction and free to rotates about its axis. The latch actuating element 507 is free to move in longitudinal direction and not free to rotates about its axis due to sides of the slots 514b and 514c preventing ears 507e to move in circumferential direction.

A stationary iron core 9, which is E-shaped similar to the E-shaped movable iron core 10, is provided with a supporting plate 9z inserted inside its window 9n and covered at their ends with elastic bodies 9m (not shown in the figure), is placed inside the lower body casing L. Shading coils 9x are provided at top end of the outer legs 9b. Individual laminated steel/iron cores are stacked and made a single unit of the stationary iron core 9 by using rivets 9y. Individual laminated steel/iron cores are stacked and made a single unit of the movable iron core 10 by using rivets 10x. The movable iron core 10 is coupled to bottom of the movable contacts support 503 by inserting the supporting plate 10y in the triangular window 10z of the core 10 and the grooves 46 of the support 503.

A bobbin 5 may include an upper plate, a lower plate, a coil 4 accommodation portion, two terminal strips 7 accommodation portion and the top plate should be able to accommodate lower portion of the returning spring 37″. The bobbin coil 4 is placed in the central leg 9a of the stationary iron core 9.

The operating coil 4 is wound around the bobbin 5, and the bobbin 5 is fixed and coupled to one side of the lower body casing L and the coil accommodation portion is partly inserted in the central leg 9a of the core 9 which is also central portion of the lower body casing L. The terminal strips 7 fixed in the bobbin 5. Terminals 4x of the operating coils are connected to the terminal strips 7. Protrudes 6 in the bobbin 5 is provided for insulating wall between two terminal strips 7 of the coil 4.

The upper body casing U5 is configured to cover the lower body casing L.

The returning spring 37″ is provided at the upper plate of the bobbin 5 and central leg 10a of the movable core 10 is inserted in the upper end of the returning spring 37″. The returning spring 37″ is compressed between the movable core 10 and the upper surface of the bobbin 5.

Now the upper body casing U5 is pressed against the lower body casing L and covered and locked. The fixed contacts 11, 12 and 13 are inserted in their respective grooves 51. Terminal washers 16 are inserted in terminal screws 17 and the terminal screws 17 are screwed in the screw terminals 11 a of the fixed contacts 11. Terminal washer 18 is inserted in terminal screw 19 and the terminal screw 19 is screwed in the screw terminal 12a of the auxiliary fixed contact 12. Terminal washer 15 is inserted in terminal screw 14 and the terminal screw 14 is screwed in the screw terminal 13a of the auxiliary fixed contact 13.

Top cover 22 is fixed to top surface, in axial direction, of the upper body casing U1 and terminal covers 20 are fixed above the fixed terminals 11 and 12. The entire sequence of the protraction and retraction is illustracted diagrammatically in the FIG.-16r. Here the latch receiving means formed within the barrel 514 has been enlarged and developed into a single plane. The small circles X₁, X₂, X₃, X₄, X₅, X₆, X₇, X₈, X₉, X₁′ represent the position of an ear 506b of the latch element 506, while the numerals adjacent to the circles in conjunction with the relative positions of teethes of the lugs 503d and 506d and lips of the slots 503k and 506k as shown in the FIGS.-16h, 16i and in the FIGS.-16m, 16n and 16p represents its location at various stages of the protraction-retraction cycle due to energisation-de energisation and again energisation-de-energisation respectively of the operating coil 4 in the present fifth embodiment EEEC2 of the invention Energy Efficient Electromagnetic Contactor EEEC.

Initially when the coil 4 is in de-energised state and the contacts are open the position of the ears 506b is at point X₁. When a voltage is impressed upon the terminals 7 of the operating coil 4 of the energy efficient electromagnetic contactor EEEC2 as described above, the stationary core 9 provided at lower portion gets magnetized and attracts movable iron core 10. As a result, the movable contacts support assembly 515 coupled to the core is lowered and the movable contacts points 34a touches the fixed contacts points 33 there by closing their electrical circuit i.e. bridging the fixed contacts 11, the returning spring 37″ and the compression spring 504 gets compressed and the latch actuating element 507 moves in the longitudinal direction guided by the ears 507e in the slots 514b and 514c and the actuating member 507 carries the latch element 506 towards bottom casing L in axial direction so that its ears 506b is now at position X₂. As soon as the ear 506b clears the vertical side M₁′ of the tooth M₁ , it is slightly rotated and at the same time is moved further towards the casing L as the inward movement of the actuating member 507 is completed until it reaches position X₃ which is above the tapered side M₁″ of the tooth M₁. This slight rotation due to the spring force of the spring 504 of the element 506 is caused by the latch element's 506 ears 506b, slipping into deeper contact with the actuating element's teeth 507f, the ear 506b moves away from the lower body casing L until it comes into engagement with the tapered side M₁″ of the tooth M₁ at position X₄. Next, the actuating member 507 drops completely out of engagement with the latch element 506 and the ear 506b now slides to the position X₅, where it is stopped by the vertical edge N₁′ of the next tooth N₁. Then, when the coil 4 is de-energised the actuating member 507 begins to return to its projecting position, by this time rotation of the element 506 results into stopping the teethes 503da, 503db, 503dc and 503dd of the lugs 503d of the cylindrical projection 503b from moving away from the casing L by the teethes 506da, 506db, 506dc and 506de of the lugs 506d of the latch element 506 respectively due to spring force of the spring 504, as shown in the FIG.-16n, resulting into slight movement of the movable contacts support assembly 515 away from the lower body casing L but the movable contacts 34 and 35 remains in contact position (closed position) with the fixed contacts 11 and 12 & 13 respectively even after de-energisation of the operating coil 4 of the fifth embodiment EEEC2 of the present invention EEEC. The ear 506b is now in retracted position. As the protraction cycle is begun by energizing the coil 4, the ear 506b is moved to position X₆ as the actuating element 507 again moved the latch element 506 towards the lower body casing L as before. The ear 506b then moves to position X₇ as it clears the tooth N₁, then drops to position X₈ due to pushing force generated by the compression spring 504 on the bushing 505 and then to the latch element 506 and then ear 506b is next slightly rotated due to the spring 504 force and again as it slides along the tapered edge N₁″ to position X₉ and next the coil 4 is de-energised the actuating element 507 begins to its projecting position and the lips 506ea, 506eb, 506ec and 506ed of the slots 506e of the element 506 pushed away from the body casing L by the teethes 503da, 503db, 503dc and 503de of the lugs 503d of the cylindrical projection 503b respectively, as shown in the FIG.-16p, and finally drops to position X₁' where it is again in protracted position and ready for the start of another cycle resulting into opening of closed contacts.

The properties of the returning spring 37″, the compression spring 504 and the contact spring 36″ and the dimention of the windows 44″ and 45″ in the movable contacts support 503 should be such that meeting the above operational requirement of the fifth embodiment EEEC2 of the present invention the Energy Efficient Electromagnetic Contactor EEEC.

START/STOP Single Push Button Control System using the Present Invention the Energy Efficient Electromagnetic Contactor EEEC.

FIGS. 19 and 20 shows a circuit diagram of a start/stop single button control system using the present invention Energy Efficient Electromagnetic Contactor EEEC. The FIG.-19 and the FIG.-20 is same except there is different symbol used for First to Fourth embodiment as EEEC11, EEEC12, EEEC13 or EEEC14 respectively and for the fifth embodiment as EEEC2 of the present invention EEEC . The wiring diagram shown in the FIG. 19 and in FIG.-20 is same. The wiring diagram shown in the FIG.-19 shows that one end of the operating coil 4 of the energy efficient electromagnetic contactor EEEC is connected to the power supply 2 through a cable 48a, NO push button switch P, cable 48b and other end is connected by a cable 48c when the coil 4 is in de-energised state. The pushbutton P is in series with the operating coil 4 connected to the power supply 2. When the coil 4 is in de-energised state the movable contact 35 does not bridge the auxiliary fixed contacts 13 i.e. the contact 13 is open. The circuit diagram shown in the FIG.19 is a condition when the electromagnetic contactor EEEC is in de-energised state and no power is fed to the Load and to the operating coil 4. When the operating coil 4 is energized by pressing NO push button switch P, the power is fed to the coil 4 and it energized resulting into closing of normally open main contacts 11-34-11 and auxiliary contacts 12-35-12 and 13-35-13. When the push button P is released the power supply 2 to the coil 4 is terminated but the closed main contacts and auxiliary contacts do not get open. Power supply 1 to the load is fed through the triple-poles main contacts 11-34-11 closing i.e. bridging of the fixed contacts 11 by the movable contacts 34. When the push button is pressed, power supply 2 to the coil 4 restored and next the push button P is released and the power supply 2 to the coil 4 terminated and the main contacts and auxiliary contacts get opened.

So there is only one push button P is used for switching ON and switching OFF power supply to the load in the present invention whereas there are two push button switches are required in the existing motor control circuit.

I claimed:

1. An Energy Efficient Electromagnetic Contactor (EEEC), as described in first to fifth embodiments, opens and closes a plurality of fixed contacts (11), (12) and (13) by means of a plurality of movable contacts (34) and (35) respectively provided in a movable contact support assembly (120) or (515) by application of electrical energy to an operating coil (4) for a short period, wherein no continuous power is required to keep its closed position and its ON or OFF state is independent of voltage applied to its operating coil (4), wherein the electromagnetic contactor comprising:
a lower body (L) having an E-shaped stationary iron core (9) supported on a plate (9z), inserted inside a window (9z) in the core (9), having its two ends covered with elastic bodies (9m) provided with shading coils (9x) at opposite two ends of the core (9) is placed at the bottom inside the body (L);
a bobbin (5) having an operating coil (4) wound around it placed in a central leg (9a) of the core (9) with its top surface having seating area on which a conical spring (37) seats and top end partition (6) with two terminal strips (7) connected to two terminals (4x) of the coil (4) for electrical power input to the operating coil (4);
a movable E-shaped iron core (10) with central leg (10a) inserted inside top smaller end of the conical spring (37) and a triangular window (10z) through which a supporting plate (10y) inserted which locked bottom portion of a movable contact support (103) or (503);
the movable contact support (103) or (503) having a plurality of windows (44″) and (45″) for movable main contacts (11) and movable auxiliary contacts (35) respectively, wherein they moved inside the windows (44″) and (45″) under spring force (36″);
a upper body casing (U1), (U2), (U3), (U4) or (U5) as described in first to fifth embodiments;
a movable contact support assembly (120) or (515), where in the assembly (120) having the contact support (103) fixed by a screw (118) to a connector (116) and the assembly (515) having a coupler (508) fixed to the contact support (503) at one end and its other end fixed to a connector (509) by a screw (510);
a pair of the upper body casing (U1), (U2), (U3) or (U4) and the contact support assembly (120) or a pair of the upper body casing (U5) and the movable contact support assembly (515);
wherein the upper portion of the movable contact support (103) inserted in a central guide groove (108) of the upper body casing (U1) or (U3) or (200) of the upper body casing (U2) or (U4) and then the connector (116) fixed by the screw (118); or wherein a spring (504), a bushing (505), a tubular latch element (506) and a tubular latch actuating element (507) inserted in sequence in upper cylindrical portion of the movable contact support (503) inserted in a central guide groove (516) of the upper body casing (U5) and then screwed by the coupler (508) and then the connector (509) fixed to the coupler (508) with the screw (510);
wherein the upper body casing (U1), (U2), (U3), (U4) or (U5) pressed and locked in the lower body casing (L);
a plurality of main fixed contacts (11) and a plurality of auxiliary fixed contacts (12) and (13) fixed in the upper body casing (U1), (U2), (U3), (U4) or (U5);
a heart shaped driving pin operating mechanism used in the pair of the upper body casing (U1), (U2), (U3) or (U4) and the contact support assembly (120) or a protraction-retraction operating mechanism used in the pair of the upper body casing (U5) and the movable contact support assembly (515);
wherein when voltage applied to the operating coil (4) for a short moment the movable contact assembly (120) or (515) gets attracted resulting into closing of contacts and when the voltage again is applied to the coil (4) for a short moment its closed contacts open due to the heart shaped driving pin operating mechanism or the protraction-retraction operating mechanism respectively.

2. The energy efficient electromagnetic contactor (EEEC) as claimed in claim 1 wherein the upper body casing (U1) made of insulating material having a plurality of partition walls (100) between two side walls (101) and (102), act like insulating wall between the two adjacent fixed contacts (11) and (12), having a central guide groove (108) supported by the outer walls (101) and (102) by a plurality of connecting plates (107) at its end, having a front top wall (105) with a window (105a) and a plurality of holes (104a) for fixing an electromagnetic armature lifter (Z1) and a front bottom wall (106) with a window (106a) and a plurality of holes (104a) for fixing a pull type actuator solenoid (Z2), a plurality of trapezoidal grooves (26) and a plurality of stoppers (110) in front end of the front upper wall (105) and front bottom wall (106) for fixing and locking a top body cover (22) to be used for support to an external movable contact support assembly, a stop groove (30) in the outer walls (101) and (102) and a stop groove (31) in the partition walls (100) for fixing a plurality of terminal covers (20) to cover the fixed contacts (11) and (12), the side walls (101) and (102) having a groove (47) for interlocking with other electromagnetic contactor, a guide groove (40) in the middle surface of the two outer partition walls (100) for guiding the movable contacts support (103), a plurality of guide grooves (51) in the partition walls (100) and the outer walls (101) for guiding the fixed contacts (11) and (12), a plurality of windows in the outer walls (105) and (106) and a plurality of horizontal partition walls (121) for allowing the fixed contacts (11), (12) and (13) to reach in a plurality of movable contacts (34) and (35) area, a stopper (38) at the bottom for locking with the lower body casing (L), the central guide groove (108) and the guide grooves (40) allows free and guided movement of the movable contacts support (103) in axial direction, the central guide grooves (108) having a plurality of steps (108ta) in a top surface (108t) connected by a connecting plate (111a) with a projection (112) at one end having a hole (119) for inserting non drive end pin (117c) of a latching member (117) and a window (108tb) in the connecting plane (111a), a tie bar (114) connected to the step (108ta) away from an edge (121a) with a suitable gap (108c) for allowing a stopper plate (Z1d) to freely move, the upper portion of the movable contacts support assembly (120) guided to be slidable on the axial line of the upper body casing (U1) in the central guide groove (108) formed between the fixed contacts (11), having a window (108ba) in the lower wall (108b) for allowing free movement of a stopper (Z2c), a guide groove (113) inside the central guide groove (108) in the bottom of a U shaped partition wall (111) over which edge of the slider stepped cut section (103f) free to slide in axial direction.

3. The energy efficient electromagnetic contactor (EEEC) as claimed in claims 1 and 2 wherein the movable contact support assembly (120) comprises:
the movable contact support (103) made of insulating material having a plurality of windows (44′) extending in longitudinal direction for a plurality of main movable contacts (34) supported together with a contact spring (36′) and a receiving member (36a′) and a plurality of windows (45′) extending in longitudinal direction for a plurality of auxiliary movable contacts (35), the slider (103c) protrudes from a middle surface (103i) of the movable contacts support (103) in axial direction having one window (103b) in longitudinal direction to accommodate and allow free movement of the stop plates (Z1d) and (Z2c) when the movable contacts support assembly (120) attracted by energization of the operating coil (4), a plurality of grooves (46) at bottom end for coupling with top surface of the movable iron core (10) having a window (10z) by inserting a plate (10y) in it and sliding the grooves (46) from two ends of the plate (10y), a heart shaped channel or latching groove (103a) having stepped two long inclined planes/grooves X, and X_{d} combined forming bigger V shape and two short inclined grooves X_{b} and X_{c} combined small V shape and one guiding groove (103d) for guiding the pin (117) in the top surface in the slider (103c), adapted to slide into and out of the central guide groove (108) in the upper body casing (U1), there by engaging/disengaging the appropriate switch contacts within the contactor (EEEC11), edge of a slider (103f) slides over the guide groove (113) of the central guide (108), the bottom end of the one end (117b) of the driving member or lathing member (117) traverse the path along the inclined curved groove Xₐ, X_{b}, X_{c} and X_{d} and there are two stable position \textcircled{b} and \textcircled{d} of the drive end pin (117b) of the driving member (117);
a connector (116) screwed in far end (103g) of the slider (103c) by a screw (118).

4. The energy efficient electromagnetic contactor (EEEC) as claimed in claims 1 to 3 wherein the movable contacts support (103) having all its movable contacts (34) and (35) attached properly to their windows (44′) and (45′) respectively by the springs (36′) and receivers (36a′) inserted in the upper body casing (U1), wherein the slider (103c) enters first in the guide groove (108) then the upper body casing (U1) pressed and fixed on the lower body casing (L) and then the pin (117) placed with its drive end pin (117b) touching heart shaped channel or latching groove (103a) and its other end (117c) in the guide groove (103d) through the hole (119) and the biasing spring (109) inserted in the outer edge (103g) of the slider (103c) in such a way that its one end inserted in a small elongated body portion (117d) stopped the vertical body portion (117e) and the guide groove (113) and other end stopped by the connector (116) for attaching external movable contacts structure such that the drive pin (117) free to rotate about pin end (117c) and the other end (117b) free to trace the stepped path of the heart shaped guide groove (103a), the movable contacts support (103) adapted to be moved to two operative positions and normally biased to its outer position by the returning spring (37′) and the suitable biasing spring (109) when the operating coil (4) de-energised, the spring (109) partly overlapped the small elongated end (117d) of the driver member (117) in such a way that it freely allowed free movement of the drive end pin (117b) into the heart shaped channel (103a) about the non drive end pin (117c) inserted in the hole (119), wherein the heart shaped channel (103a) inclined and stepped to provide positive snap action switching and means provided to impart a seesaw motion to the driving member (117), thereby to move the drive pin (117b) of the driving member (117) into positive camming engagement with the stepped upper surface of the channel (103a, the drive pin (117b guided by side wall of the heart shaped channel (103a), a stopper metal pin (115) touching the edge (117a) fixed in the top surface (108t) of the guide groove (108) to prevent coming out of the pin (117).

5. The energy efficient electromagnetic contactor (EEEC) as claimed in claims 1 to 4 wherein heart shaped-driving pin operating mechanism in which when a voltage impressed upon the operating coil (4) the movable contact support assembly (120) attracts, the conical spring (137′) compressed, the biasing spring compressed and the drive end pin (117b) traverses longer inclined path Xa of the heart shaped channel (103a) from a stable point \textcircled{d} to a non stable point \textcircled{a}, now the voltage disconnected the drive end pin (117b) traverses the shorter inclined path Xb from the unstable point \textcircled{a} to the next stable point \textcircled{b} and the fixed contacts and the movable contacts touches and the circuit closed; now the voltage again applied to the coil (4) the movable contact support assembly (120) attracted and the drive end pin (117b) traverses a shorter inclined path Xc and reached a unstable point \textcircled{c} and now the voltage disconnected then the pin end (117b) traverses a longer inclined path Xd and reached a stable point \textcircled{d} and the closed contact gets open.

6. The energy efficient electromagnetic contactor (EEEC) as claimed in claim 1 wherein the upper body casing (U2) made of insulating material having the plurality of partition walls (100) between the two side walls (101) and (102), act like insulating wall between the two adjacent fixed contacts (11) and (12), having a central guide groove (200) supported by the outer walls (101) and (102) by the plurality of connecting plates (107) at its end, having the front top wall (105) with the window (105a) and the plurality of holes (104a) for fixing the electromagnetic armature lifter (Z1) and the front bottom wall (106) with the window (106a) and the holes (104a) for fixing the pull type actuator solenoid (Z2), the plurality of trapezoidal grooves (26) and the plurality of stoppers (110) in front end of the front upper wall (105) and the front bottom wall (106) for fixing and locking the top body cover (22) to be used for support to an external movable contact support assembly, the stop groove (30) in the outer walls (101) and (102) and the stop groove (31) in the partition walls for fixing the plurality of terminal covers (20) to cover the fixed contacts (11) and (12), the side walls (101) and (102) having the groove (47) for interlocking with other electromagnetic contactor, the guide groove (40) in the middle surface of the two outer partition walls (100) for guiding the movable contacts support (103), the plurality of guide grooves (51) in the partition walls (100) and the outer walls (101) for guiding the fixed contacts (11) and (12), the plurality of windows in the outer walls (105) and (106) and the plurality of partition walls (121) for allowing the fixed contacts (11), (12) and (13) to reach in the plurality of movable contacts (34) and (35) area, the stopper (38) at the bottom for locking with the lower body casing (L), the central guide groove (200) and the guide grooves (40) allows free and guided movement of the movable contacts support (103) in axial direction, the central guide grooves (200) having the plurality of steps (200ta) in a top surface (200t) connected by a connecting plate (201) having a screw hole (203a) for screwing in a screw (203) and a window (200tb) in the connecting plane (201), the tie bar (114) connected to the step (200ta) away from the edge (121a) with a suitable gap (200c) for allowing the stopper plate (Z1d) to freely move, the upper portion of the movable contacts support assembly (120) guided to be slidable on the axial line of the upper body casing (U2) in the central guide groove (200) formed between the fixed contacts (11), having a window (200ba) in the lower wall (200b) for allowing free movement of the stopper (Z2c), the guide groove (113) inside the central guide groove (200) in bottom of the U shaped partition wall (111) over which edge of the slider stepped cut section (103f) free to slide in axial direction.

7. The energy efficient electromagnetic contactor (EEEC) as claimed in claims 1 and 6 wherein the movable contact support assembly (120) comprises:
the movable contact support (103) made of insulating material having a plurality of windows (44′) extending in longitudinal direction for a plurality of main movable contacts (34) supported together with a contact spring (36′) and a receiving member (36a′) and a plurality of windows (45′) extending in longitudinal direction for a plurality of auxiliary movable contacts (35), the slider (103c) protrudes from a middle surface (103i) of the movable contacts support (103) in axial direction having one window (103b) in longitudinal direction to accommodate and allow free movement of the stop plates (Z1d) and (Z2c) when the movable contacts support assembly (120) attracted by energization of the operating coil (4), a plurality of grooves (46) at bottom end for coupling with top surface of the movable iron core (10) having a window (10z) by inserting a plate (10y) in it and sliding the grooves (46) from two ends of the plate (10y), a heart shaped channel or latching groove (103a) having stepped two long inclined planes/grooves Xₐ and X_{d} combined forming bigger V shape and two short inclined grooves X_{b} and X_{c} combined small V shape, adapted to slide into and out of the central guide groove (200) in the upper body casing (U2, there by engaging/disengaging the appropriate switch contacts within the contactor (EEEC12), edge of the slider (103f) slides over the guide groove (113) of the central guide (200), the bottom end of the pin (202b) traverse the path along the inclined curved groove Xₐ, X_{b}, X_{c} and X_{d} and there are two stable position b and d of the drive end pin (202b) of the pin-lever (202);
a connector (116) screwed in far end (103g) of the slider (103c) by a screw (118).

8. The energy efficient electromagnetic contactor (EEEC) as claimed in claims 1, 6 and 7 wherein the movable contacts support (103) having all its movable contacts (34) and (35) attached properly to their windows (44′) and (45′) respectively by the springs (36′) and receivers (36a′) inserted in the upper body casing (U2) such that the slider (103c) enters first in the guide groove (200) then the upper body casing (U2) pressed and fixed on the lower body casing (L) and then the pin-lever (202) fitted and coupled to the contact plate (201) by placing the spring (204) above the head (202c) and inserting the screw (203) in the hole (202d) and screw it in the hole (203a) of the connecting plate (201) and the pin (202) free to rotate about the axis of the hole (202d), the conical compression spring (204) keep the lever (202) in pressed condition, the pin (202b) free to trace the stepped path of the heart shaped guide groove (103a), the movable contacts support (103) adapted to be moved to two operative positions and normally biased to its outer position by the returning spring (37′), the pin (202b) guided by side wall of the heart shaped channel (103a).

9. The energy efficient electromagnetic contactor (EEEC) as claimed in claims 1, 6, 7 and 8 wherein heart shaped-driving pin operating mechanism in which when a voltage impressed upon the operating coil (4) the movable contact support assembly (120) attracted, the conical spring (137′) compressed and the pin (202b) traverses longer inclined path Xa of the heart shaped channel (103a) from a stable point \textcircled{d} to a non stable point \textcircled{a}, now the voltage disconnected the drive end pin (117b) traverses the shorter inclined path Xb from unstable point \textcircled{a} to the next stable point \textcircled{b} and the fixed contacts and the movable contacts touches and the circuit closed; now the voltage again applied to the coil (4) the movable contact support assembly (120) attracted and the pin (202b) traverses a shorter inclined path Xc and reached the unstable point \textcircled{c} and now the voltage disconnected then the pin (202b) traverses a longer inclined path Xd and reached the stable point \textcircled{d} and the closed contact gets open.

10. The energy efficient electromagnetic contactor (EEEC) as claimed in previous claims wherein the electromagnetic armature lifter (Z1) fitted in a window (105a) in the top surface (105) of the upper body casing (U1) or (U2) having the stopper (Z1d) free to slide over the slider (103c) and ready to enter in the window (103b) when the coil (4) energised attracting the movable contact support assembly (120) and prevent retraction of the assembly (120) when the coil (4) de-energised and then energised and de -energised, when a coil (Z1g) of the armature lifter (Z1) energised attracting a lever (Z1c) resulting into lifting of the stopper (Z1d) freeing interlocking to the movable contact support assembly (120).

11. The energy efficient electromagnetic contactor (EEEC) as claimed in claims 1 to 9 wherein the pull type actuator (Z2) in a window (106a) in the bottom surface (106) of the upper body casing (U1) or (U2) having the stopper (Z2c) free to slide over the slider (103c and ready to enter in the window (103b) from bottom side when the coil (4) energised attracting the movable contact support assembly (120) and prevent retraction of the assembly (120) when the coil (4) de-energised and then energised and de -energised, when a coil (Z2a) of the actuator (Z2) energised attracting a lever (Z2b) resulting into lifting of the stopper (Z2c) freeing interlocking to the movable contact support assembly (120).

12. The energy efficient electromagnetic contactor (EEEC) as claimed in claims 1, 2 and 6 wherein the upper body (U3) or (U4) comprises (U1) or (U2) respectively having outer body upper wall (300) with a cover (300a) fitted with a screw (300b) and outer body lower wall (300′).

13. The energy efficient electromagnetic contactor (EEEC) as claimed in claim 1 wherein the upper body casing (U5) made of insulating material having a plurality of partition walls (100) between two side walls (501) and (502), act like insulating wall between the two adjacent fixed contacts (11) and (12), having a central guide groove (516) supported by the outer walls (501) and (502) by a plurality of connecting plates (511) at its end, having a front end upper and lower outer horizontal walls (500), a plurality of trapezoidal grooves (26) and a plurality of stoppers (110) in front end of the front upper wall (500) and front bottom wall (500) for fixing and locking a top body cover (22) to be used for support to an external movable contact support assembly, a stop groove (30) in the outer walls (501) and (502) and a stop groove (31) in the partition walls (100) for fixing a plurality of terminal covers (20) to cover the fixed contacts (11) and (12), the side walls (501) and (502) having a groove (47) for interlocking with other electromagnetic contactor, a guide groove (40) in the middle surface of the two outer partition walls (100) for guiding the movable contacts support (503), a plurality of guide grooves (51) in the partition walls (100) and the outer walls (501) and (502) for guiding the fixed contacts (11) and (12), a plurality of windows in the outer walls (500) and a plurality of horizontal partition walls (513) for allowing the fixed contacts (11), (12) and (13) to reach in the plurality of movable contacts (34) and (35) area, a stopper (38) at the bottom for locking with the lower body casing (L), the central guide groove (516) and the guide grooves (40) allows free and guided movement of the movable contacts support (503) in axial direction, the central guide grooves (516) with horizontal walls (513) and vertical walls (512) having a barrel (514), wherein the barrel (514) having a series of radially spaced inwardly projecting lugs (514a), a series of longitudinally extending deep recess or slots (514b) and an inner longitudinally extending shallow recess or slot, the barrel (514) allowing free movement of cylindrical projections in a moving contact assembly (515) in axial direction, the upper portion of the movable contacts support assembly (515) guided to be slidable on the axial line of the upper body casing (U5) in the central guide groove (516) formed between the fixed contacts (11).

14. The energy efficient electromagnetic contactor (EEEC) as claimed in claims 1 and 13 wherein the movable contact support assembly (515) comprises:
a movable contact support (503) made of insulating material having a plurality of windows (44″) extending in longitudinal direction for a plurality of main movable contacts (34) supported together with a contact spring (36″) and a receiving member (36a″) and a plurality of windows (45″) extending in longitudinal direction for a plurality of auxiliary movable contacts (35), a plurality of grooves (46) at bottom end for coupling with top surface of the movable iron core (10) having a window (10z) by inserting a plate (10y) in it and sliding the grooves (46) from two ends of the plate (10y), coaxial cylinders (503a), (503b) and (503c) in series protrudes from the middle face surface (503g) of the contact support (503), the cylinder (503a) protrudes from the middle surface (503g), the cylinder (503b) protrudes from face of the cylinder (503a) in axial direction having a series of radially spaced outwardly projecting lugs (503d) in outer periphery near its opposite end, the cylinder (503c) protrudes in axial direction from the cylinder (503b), wherein the first, second, third and fourth teethes (503da), (503db), (503dc) and (503dd) respectively of the projecting lugs (503d) with equal width and depth, the first, second, third and fourth lips (503ea), (503eb), (503ec) and (503ed) respectively of the projecting lugs (503d) with equal width and depth, a free end (503f) of the cylinder (503c) threaded for coupling the coupler (508), the movable contacts (34) and (35) under the pressure of the contacts spring (36a″) free to move in axial direction in the windows (44″) and (45″) respectively, the movable contacts (34) under the pressure of the contacts spring (36a″) free to move in axial direction in the windows (45′), adapted to slide into and out of the central guide groove (516) in the upper body casing (U5), there by engaging/disengaging the appropriate switch contacts within the contactor (EEEC2);
the coupler (508) screwed in the cylinder (503c) by its one end and other end connected to a connector (509) by a screw (510);
the connector (509) for connecting external movable contact support assembly.

15. The energy efficient electromagnetic contactor (EEEC) as claimed in claims 1, 13 and 14 wherein the movable contacts support (503) having all its movable contacts (34) and (35) attached properly to their windows (44″) and (45″) respectively by the springs (36″) and receivers (36a″) inserted in the upper body casing (U5), wherein a spring (504), a bushing (505), a latch element (506) and then a latch actuating element (507) inserted in the cylindrical projection (503c), (503b), (503a) in sequence, wherein face of the spring (504) seats on the surface (503g) and the other end seats against the edge (505c) of the bushing (505), the opposite edge (505c) rest against the edge (506m) of the latching element (506) and free to rotate relative to each other, the outer body (506a) of the tubular latch element (506) inserted inside the latch actuating element (507), the projecting teethes (506c) of the element (506) seats against the upwardly teethes (507f) of the element (507), wherein the complete assembly now inserted in the barrel (514) in the central guide groove (516) of the upper body casing (U5), the cylindrical projection (503c) comes out of the hollow portion (507c) of the latch actuating element (507) and screwed by the coupler (508) in the threaded portion (503f) of the cylindrical projection (503c), the ears (507e) of the latch actuating element (507) inserted in the slots (514b) and the (514c) of the barrel (514) and free to move in longitudinal direction, the downwardly projecting teethes (506c) of the latch actuating element (506) seats on the upwardly extending teethes (507f) seats of the latch actuating element (507), the outer surface (506a) of the lower portion of the element (506) inserted inside the teethes (507f) end of the element (507), the latch element (506) free to move in longitudinal direction and free to rotates about its axis, the coupler (505) free to move in longitudinal direction and free to rotates about its axis, the latch actuating element (507) free to move in longitudinal direction and not free to rotates about its axis due to sides of the slots (514b) and (514c) preventing ears (507e) to rotate in circumferential direction and the upper body casing (U5) pressed and fixed on the lower body casing (L), the connector (509) fitted to the coupler (508) by a spring (510), the movable contacts support (503) adapted to be moved to two operative positions and normally biased to its outer position by the returning spring (37′) when the operating coil (4) de-energised.

16. The energy efficient electromagnetic contactor (EEEC) as claimed in claims 1, 13 to 15 wherein the protraction-retraction operating mechanism wherein entire sequence of the protraction and retraction an ear (506b) of the latch element (506) followed small circles represented by positions X₁, X₂, X₃, X₄, X₅, X₆, X₇, X₈, X₉, X₁′, while the numerals adjacent to the circles in conjunction with the relative positions of teethes of the lugs (503d) and (506d) and lips of the slots (503k) and (506k) represents its location at various stages of the protraction-retraction cycle due to energisation-de energisation and again energisation-de-energisation respectively of the operating coil (4) in the fifth embodiment (EEEC2), wherein when the coil (4) in de-energised state and the contacts in opened condition the ears (506b) at point X₁, wherein when a voltage impressed upon the operating coil (4) the stationary core (9) provided at lower portion gets magnetized and attracts movable iron core (10) and the movable contacts support assembly (515) coupled to the core (10) lowered and the movable contacts points (34a) touched the fixed contacts points (33) there by closing their electrical circuit by bridging the fixed contacts (11), a returning spring (37″) and the compression spring (504) gets compressed and the latch actuating element (507) moved in longitudinal direction guided by the ears (507e) in the slots (514b) and (514c) and the actuating member (507) carried the latch element (506) towards bottom casing (L) in axial direction so that its ears (506b) at position X₂, as soon as the ear (506b) cleared a vertical side M₁′ of a tooth M₁ , the latch element (506) slightly rotated and at same time moved further towards the casing (L) as the inward movement of the actuating member (507) completed until it reached the position X₃ above a tapered side M₁″ of the tooth M₁, slight rotation of the latch element (506) due to spring force of the spring (504) caused by the ears (506b) of the latch element (506), slipped into deeper contact with the teeth (507f) of the actuating element (507), the ear (506b) moved away from the lower body casing (L) until it came into engagement with the tapered side M₁″ of the tooth M₁ at position X₄, the actuating member (507) drops completely out of engagement with the latch element (506) and the ear (506b) now slides to the position X₅ stopped by the vertical edge N₁′ of the next tooth N₁, wherein when the coil (4) is de-energised the actuating member (507) begin to return to its projecting position, by this time rotation of the element (506) resulted into stopping the teethes (503da), (503db), (503dc) and (503dd) of the lugs (503d) of the cylindrical projection (503b) from moving away from the casing (L) by the teethes (506da), (506db), (506dc) and (506de) of the lugs (506d) of the latch element (506) respectively due to spring force of the spring (504), resulting into slight movement of the movable contacts support assembly (515) away from the lower body casing (L) but the movable contacts (34) and (35) remains in contact position (closed position) with the fixed contacts (11) and (12) & (13) respectively even after de-energisation of the operating coil (4), the ear (506b) now in retracted position, the protraction cycle begun by energizing the coil (4), the ear (506b) moved to position X₆ as the actuating element (507) again moved the latch element (506) towards the lower body casing (L), the ear (506b) then moved to position X₇ after cleared the tooth N₁, then dropped to position X₈ due to pushing force generated by the compression spring (504) on the bushing (505) and then to the latch element (506) and then ear (506b) slightly rotated due to the spring (504) force and again it slide along the tapered edge N₁″ to position X₉ and then the coil (4) de-energised the actuating element (507) begin to its projecting position and the lips (506ea), (506eb), (506ec) and (506ed) of the slots (506e) of the element (506) pushed away from the body casing (L) by the teethes (503da), (503db), (503dc) and (503de) of the lugs (503d) of the cylindrical projection (503b) respectively and finally dropped to position X₁′ where it is again in protracted position and ready for start of another cycle resulting into opening of closed contacts.

17. The energy efficient electromagnetic contactor (EEEC) as claimed in claims 1, 13 to 16 wherein the tubular latch element (506) a series of radially spaced ears (506b) extend outwardly from the upper portion of the latch element (506), and the bottom edge of the ears (506b) tapered so as to form the downwardly projecting teeth (506c), a tubular outer surface (506a), a top inner surface (506g) projected inwardly in radial direction (506h) and then projected in axial direction, a series of radially spaced inwardly projected lugs (506d) extend inwardly from lower portion of the latch element (506), a hole (506f) near bottom end and allow only the cylinder (503c) to pass through it freely, the series of first, second, third and fourth teethes (506da), (506db), (506dc) and (506dd) respectively are of equal width and depth, the series of first, second, third and fourth lips (506ea), (506eb), (506ec) and (506ed) respectively are of equal width and depth, the inner diameter of the tubular lath element hollow tube (506j) slightly greater than the cylindrical diameter of the cylinder (503b) and the cylinder (503b) free to move inside the hollow tube (506j) in axial direction, the teethes (503da), (503db), (503dc) and (503dd) of the cylinder (503b) touching the teethes (506da), (506db), (506dd) and (506de) of the latch element (506) respectively and touching the lips (506ea), (506eb), (506ec) and (506ed) of the latch element (506) during one operation of ON and one operation of OFF respectively, wherein during next ON operation the teethes (503da), (503db), (503dc) and (503dd) of the cylinder (503b) touched the teethes (506db), (506dc), (506dd) and (506de) of the latching element (506) due to their rotation and axial movement, wherein during next OFF operation the teethes (503da), (503db), (503dc) and (503dd) of the cylinder (503b) touched the lips (506eb), (506ec), (506ed) and (506ee) of the latching element (506), wherein during each operation the latch element (506) rotates one step ahead with respected to the latch actuating element (507) about its axis, the top cylindrical edge of the latch actuating element (506) touched the edge (505c) of the outer body projection (505b) and the inner body (505a) of the bushing (505) inserted from the top opening (506i) of the latch element (506), the bushing (505) and the latching element (506) rotates about its axis during operation of the present invention (EEEC).

18. The energy efficient electromagnetic contactor (EEEC) as claimed in claims 1, 13 to 17 wherein the tubular latch actuating element (507) having a series of spaced ears (507e) extend outwardly from the top portion of the latch actuating element (507) and a series of upwardly extending teeth (507f) defined by the top edge of the element (507), the radially projecting ears (507e) extended into and longitudinally movable within the slots (514b) and (514c) defined in the barrel (514) section but restrained against rotation about its axis by sides of the slots (514a) defined in the barrel (514a) section, wherein the tubular latch actuating element (507) having interiorly the annular lip (507d) further projected in axial direction in the hollow lower portion (507c) of the element (507), wherein the diameter of the tubular hollow portion (507) slightly bigger than cylindrical diameter of the cylinder (503c) allowing free movement of the moving contacts support assembly (515).

19. The energy efficient electromagnetic contactor (EEEC) as claimed in previous claims wherein START/STOP single push button control system used for switching ON/OFF load wherein a normally open push button (P) connected in series with the operating coil (4) and a power supply (power supply 2) using cables (48a), (48b) and (48c), wherein the push button (P) pressed for a short moment energised the electromagnet contactor (EEEC11), (EEEC12), (EEEC13), (EEEC14) or (EEEC2) for short moment resulting into closing their contacts and power supply (power supply 1) to a load (a load) fed, again push button (P) pressing for a short moment energised the electromagnet contactor (EEEC11), (EEEC12), (EEEC13), (EEEC14) or (EEEC2) for short moment thereafter opening their contacts resulting into opening connection of power supply (power supply 1) to a load (a load).
